(19) United States
(12) Patent Application Publication
(10) Pub. No.: US 2004/0249937 A1
(43) Pub. Date: Dec. 9, 2004

(54) Performance management method, system and program

(76) Inventors: Hidekazu Tachihara, Fujisawa (JP); Yuji Akamatsu, Yokohama (JP); Shuji Fujino, Ebina (JP); Katsunori Yoshii, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/807,250

(22) Filed: Mar. 24, 2004

(30) Foreign Application Priority Data
Jun. 3, 2003 (JP) 2003-158263

(51) Int. Cl. G06F 15/173; G06F 9/46

(52) U.S. Cl. 709/224; 718/100

(57) ABSTRACT

A performance management method for monitoring states of programs and system resources and managing performance of a computer system includes a step of referring to business information representing programs and system resource used in computers and generating and managing correlation information representing correlations among them, and a step of generating monitoring structure information representing a structure for monitoring the programs and system resource, in accordance with the generated correlation information.

### BACKGROUND OF THE INVENTION

The present invention relates to a performance management system for monitoring states of programs and system resources and managing the performance of a computer system. In particular, the present invention relates to a technique that is effective to performance management for generating a monitoring structure, such as a monitoring tree, to monitor programs and system resources for business processing, and conducting performance management of a computer system.

In integrated system performance management for managing the performance of a computer system, there is a need for a technique for grouping and hierarchizing various system resources (such as servers, applications, databases, network devices and storage devices) existing in the system from the viewpoint of business such as business, organization and applications in order to grasp the range of the influence caused by a fault. In this case, a “business configuration defining work” for previously grouping system resources into meaningful units of business or the like is needed, and conventionally a method described below has been used.

In one method, system resources existing on the system are previously displayed as icons, and the user manually groups system resource icons forming a certain business. In another method, the user manually defines an attribute rule for identifying system resources that form a business and system resources that form a business are automatically extracted on the basis of the rule, and thereby a business configuration is defined.

Furthermore, in a monitoring structure such as a monitoring tree, only a previously given structure is typically used. It cannot be easily conducted to freely alter the monitoring structure itself every user. For example, in the invention disclosed in JP-A-2000-181756, a method of displaying correlation relations among software modules is displayed by icons and displaying propagation of influence at the time of a fault and the state change caused by the fault has been proposed. As for the relations (hierarchical structure) among modules, however, a hierarchical structure given as a predetermined structure is used.

In the business configuration definition work in the conventional technique, the user must manually conduct system resource icon grouping and definition of the attribute rule for identifying system resources that form business. In addition, it must be executed repetitively as many times as the number of businesses. This results in a problem that the business configuration definition work conducted by the user becomes complicated and the load becomes high as the system scale becomes large.

Furthermore, in the conventional technique, there is a problem that it is not considered to create different monitoring structures according to the user's need when creating a monitoring structure to monitor programs and system resources.

### SUMMARY OF THE INVENTION

An object of the present invention is to solve the problems and provide a technique capable of efficiently generating monitoring structure information that represents various structures such as a monitoring structure relating a program to a specific system resource and a monitoring structure relating the specific system resource to another system resource.

Another object of the present invention is to provide a technique capable of providing a monitoring structure suitable for the user while considering the monitoring subject range and authority of each user, preventing access to unnecessary information, lightening the user's setting work burden, lightening the network load and raising the information reading rate, altering the monitoring structure according to an alteration of business information on computers, or omitting the reference to unnecessary business information and increasing the efficiency of correlation information generation.

In accordance with the present invention, in performance management for monitoring states of programs and system resources and managing the performance of a computer system, monitoring structure information for monitoring programs and system resources used in computers is generated on the basis of business information representing the programs and system resources.

In performance management according to the present invention, a menu of “policies” are displayed and information selected by the user is managed in a DB (Database), in order to grasp monitoring needs and a taste of each user.

Here, the “policy” indicates criteria to be used when generating a monitoring structure. There are a grouping policy for grouping system resources to be monitored on the basis of the business (such as a job group or business application), domain, organization and business division of duties, and region and position information, a monitoring item policy for selecting a monitoring subject item (such as business or a system resource) according to the user's division of duties, a monitoring viewpoint policy for altering the monitoring hierarchical structure on the basis of the center around which the system should be monitored (such as around business or around a system resource), and a virtualization policy for taking contents of virtualization, such as cluster correspondence (virtualization of a plurality of servers), SAN (Storage Area Network) correspondence (virtualization of a plurality of storages), VLAN (Virtual LAN) correspondence (network virtualization), in the monitoring structure.

Subsequently, in accordance with the set policy, existing business information including business configuration information, such as management data of other management product groups (such as job management, network management and application management) used in the computers and clustering software setting information, is collected, and correlation information representing the correlation among programs and system resources in computers is generated and managed.

And by merging the generated correlation information in accordance with the basic structure of the monitoring according to the user's policy and generating monitoring structure information representing the structure for monitoring the programs and system resources, a monitoring structure (for example, a monitoring tree) conforming to the user's need is generated. Owing to these kinds of processing, a monitoring structure complying with the viewpoint the user desires and items the user desires to monitor can be automatically generated on the basis of business information of the computers.

Furthermore, the contents of the menu for selecting the policy may be altered from user to user according to the type of industry and authority. Partial or all setting of the policy may be conducted forcibly according to preset contents. As a result, it becomes possible to keep items the user obviously does not select and items desired not to be selected by the user from being displayed, and the user's setting work burden can be lightened.

According to the performance management of the present invention, the monitoring structure information for monitoring programs and system resources used by computers is generated on the basis of business information representing the programs and system resources, as heretofore described. Therefore, it is possible to efficiently generate monitoring structure information that represents various structures such as a monitoring structure relating a program to a specific system resource and a monitoring structure relating the specific system resource to another system resource.

Other objects, features and advantages of the invention will become apparent from the following description of the embodiments of the invention taken in conjunction with the accompanying drawings.

### BRIEF DESCRIPTION OF THE DRAWING

FIG. 1 is a diagram showing a general configuration of a performance management system according to a first embodiment;

FIG. 2 is a flow chart showing a general processing procedure according to a first embodiment;

FIG. 3 is a flow chart showing a processing procedure in a policy acquisition unit 101 according to a first embodiment;

FIG. 4 is a flow chart showing a processing procedure in a basic structure management unit 102 according to a first embodiment;

FIG. 5 is a flow chart showing a processing procedure in a relation management unit 103 according to a first embodiment;

FIG. 6 is a flow chart showing a processing procedure in a monitoring structure generation unit 104 according to a first embodiment;

FIG. 7 is a diagram showing a data structure of a policy item DB 111 according to a first embodiment;

FIG. 8 is a diagram showing a data structure of a user policy DB 112 according to a first embodiment;

FIG. 9 is a diagram showing a data structure of a basic structure DB 113 according to a first embodiment;

FIG. 10 is a diagram showing a data structure of a configuration information management DB 114 according to a first embodiment;

FIG. 11 is a diagram showing a data structure of a business information management DB 123 according to a first embodiment;

FIG. 12 is a diagram showing a data structure of a data transformation DB 115 according to a first embodiment;

FIG. 13 is a diagram showing a data structure of a correlation DB 116 according to a first embodiment;

FIG. 14 is a diagram showing a data structure of a monitoring structure DB 117 according to a first embodiment;

FIG. 15 is a diagram showing an example of a policy setting view according to a first embodiment;

FIG. 16 is a diagram showing an example of a policy item DB 111 according to a first embodiment;

FIG. 17 is a diagram showing an example of a user policy DB 112 according to a first embodiment;

FIG. 18 is a diagram showing an example of a basic structure DB 113 according to a first embodiment;

FIG. 19 is a diagram showing an example of a configuration information management DB 114 according to a first embodiment;

FIG. 20 is a diagram showing an example of a business information management DB 123 according to a first embodiment;

FIGS. 21A and 21B are diagrams showing an example of a data transformation DB 115 according to a first embodiment;

FIG. 22 is a diagram showing an example of a correlation DB 116 according to a first embodiment;

FIG. 23 is a diagram showing an example of a monitoring structure DB 117 according to a first embodiment;

FIG. 24 is a diagram showing a display example of a monitoring tree according to a first embodiment;

FIG. 25 is a diagram showing a schematic configuration of a performance management system according to a second embodiment;

FIG. 26 is a diagram showing an example of a policy setting view at filtering execution according to a second embodiment;

FIG. 27 is a flow chart showing a processing procedure in a filter setting unit 2501 according to a second embodiment;

FIG. 28 is a flow chart showing a processing procedure in a policy acquisition unit 2502 according to a second embodiment;

FIG. 29 is a diagram showing a data structure of a filter setting DB 2503 according to a second embodiment;

FIG. 30 is a diagram showing an example of a filter setting DB 2503 according to a second embodiment;

FIG. 31 is a diagram showing a general configuration of a performance management system according to a third embodiment;

FIGS. 32A and 32B are diagrams showing an example of a policy setting view at the time of forced policy setting according to a third embodiment;

FIG. 33 is a flow chart showing a processing procedure in a forced policy setting unit 3101 according to a third embodiment;

FIG. 34 is a diagram showing a general configuration of a performance management system according to a fourth embodiment;

FIG. 35 is a flow chart showing a processing procedure in a relation management unit 3401 according to a fourth embodiment;

FIG. 36 is a diagram showing a data structure of a business information integration DB 3402 according to a fourth embodiment;

FIG. 37 is a diagram showing a general configuration of a performance management system according to a fifth embodiment;

FIG. 38 is a flow chart showing a processing procedure in a monitoring structure automatic update unit 3701 according to a fifth embodiment;

FIG. 39 is a diagram showing a general configuration of a performance management system according to a sixth embodiment;

FIG. 40 is a flow chart showing a processing procedure in a relation management unit 3901 according to a sixth embodiment;

FIG. 41 is a diagram showing a data structure of an information selection DB 3902 according to a sixth embodiment; and

FIG. 42 is a diagram showing an example of an information selection DB 3902 according to a sixth embodiment.

### DETAILED DESCRIPTION OF THE EMBODIMENTS

### First Embodiment

Hereafter, a performance management system according to a first embodiment, which collects necessary information from business computers on the system on the basis of the policy selected by each user and generates a monitoring structure meeting the user's needs, will be described.

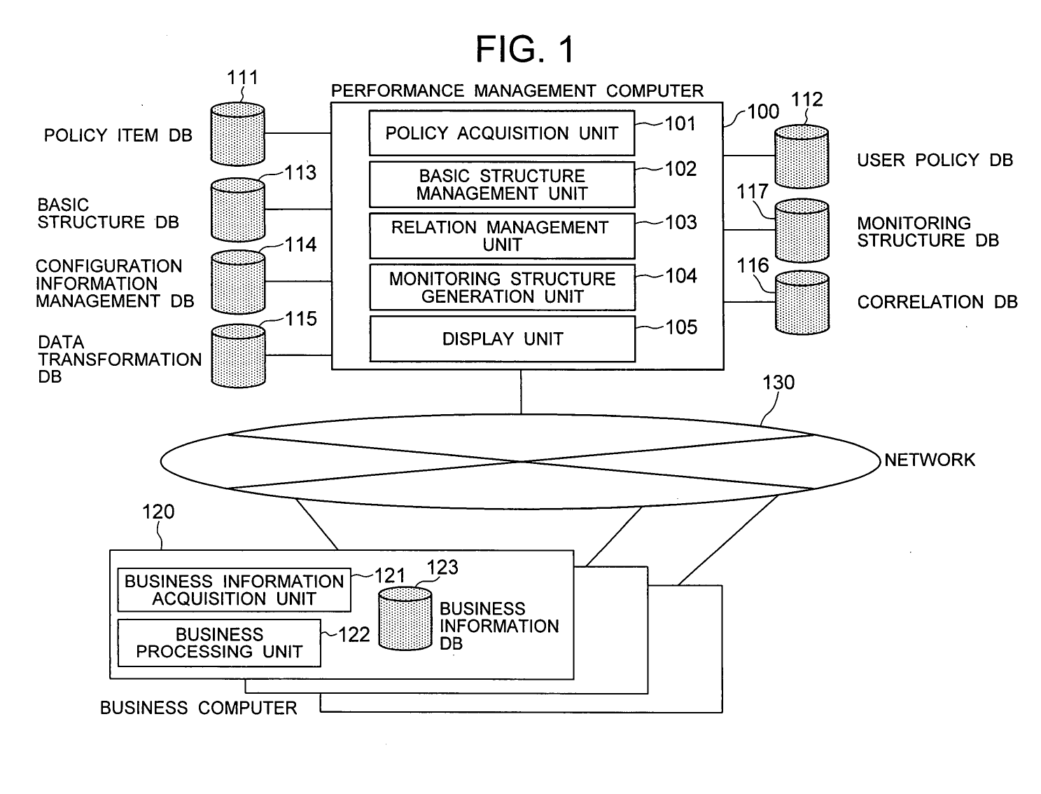

FIG. 1 is a diagram showing a general configuration of a performance management system according to the present embodiment. As shown in FIG. 1, a performance management computer 100 includes a policy acquisition unit 101, a basic structure management unit 102, a relation management unit 103, a monitoring structure generation unit 104 and a display unit 105.

The policy acquisition unit 101 is a processing unit that acquires a policy selected by the user. The basic structure management unit 102 is a processing unit for setting and managing a basic structure for monitoring programs and system resources on the basis of the policy acquired by the policy acquisition unit 101.

The relation management unit 103 is a processing unit for referring to business information, which represents programs and system resources used in business computers, and generating and managing correlation information representing correlation among them. The monitoring structure generation unit 104 is a processing unit for generating monitoring structure information, which represents a structure for monitoring the programs and system resources, in accordance with the generated correlation information. The display unit 105 is a processing unit for displaying a monitoring structure on the basis of the generated monitoring structure information. By the way, it is not always necessary that the policy acquisition unit 101, the basic structure management unit 102, the relation management unit 103, the monitoring structure generation unit 104 and the display unit 105 are present on one performance management computer 100, but they may be divisionally disposed on a plurality of performance management computers 100.

A program for making the performance management computer 100 function as the policy acquisition unit 101, the basic structure management unit 102, the relation management unit 103, the monitoring structure generation unit 104 and the display unit 105 is recorded on a media such as a CD-ROM and stored on a magnetic disk or the like, and thereafter loaded in a memory and executed. The media for recording the program thereon may be a media other than the CD-ROM. The program may be installed from the media into an information processing apparatus. Or the program may be used by accessing the media via a network.

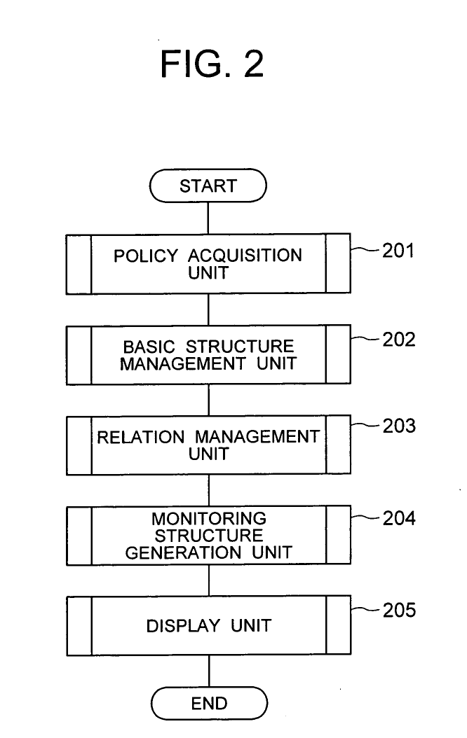

FIG. 2 is a flow chart showing a general processing procedure in the present embodiment. At step 201, the policy acquisition unit 101 in the performance management computer 100 displays a menu for setting a policy and accepts an input from the user, and thereby conducts processing for acquiring a policy set by the user.

The policy in the present embodiment indicates criteria to be used when generating a monitoring structure to monitor programs and system resources. There are the above-described grouping policy, monitoring item policy, monitoring viewpoint policy and virtualization policy. However, another policy may be added.

At step 202, the basic structure management unit 102 conducts processing of setting and managing the basic structure, which represents a basic structure of the monitoring structure for monitoring the programs and system resources, on the basis of the policy acquired by the policy acquisition unit 101.

At step 203, the relation management unit 103 conducts processing of collecting necessary business information (such as job group configuration information) concerning business configuration from other management product groups (such as job management, network management, and application management) used in the business computers in accordance with the acquired policy, and generating and managing correlation information, which represents correlation among programs and system resources in the business computers.

At step 204, the monitoring structure generation unit 104 generates a monitoring structure (such as a monitoring tree) conforming to the user's needs by merging the generated correlation information in accordance with the above-described basic structure and generating monitoring structure information, which represents a structure for monitoring the programs and system resources. Owing to these kinds of processing, it is possible to automatically generate a monitoring structure complying with a viewpoint the user desires and items the user desires to monitor.

At step 205, the display unit 105 conducts processing of displaying a monitoring structure such as a monitoring tree on the basis of information of the generated monitoring structure.

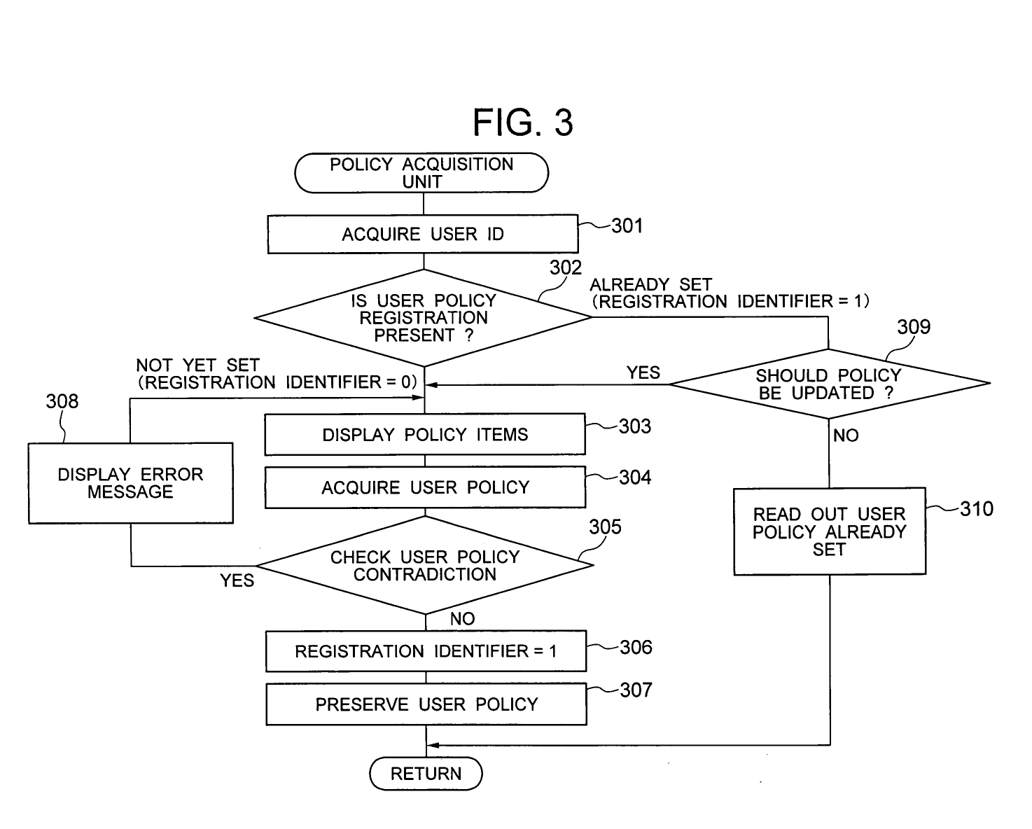

FIG. 3 is a flow chart showing a processing procedure in the policy acquisition unit 101 according to the present embodiment. At step 301, the policy acquisition unit 101 acquires a user ID for identifying the user for whom the policy acquisition is to be conducted.

At step 302, the policy acquisition unit 101 reads out a registered identifier corresponding to the acquired user ID by referring to the user policy DB 112, and determines whether a user policy is registered by determining whether “1” is set in the registered identifier. If the registration is not yet set, the processing proceeds to step 303. If the registration has already been set, the processing proceeds to step 309. By the way, the registration identifier is an identifier for identifying whether the user has already set a policy. In the present embodiment, the method of identifying whether there is registration by setting “0” if the registration is not yet set and setting “1” if the registration has already been set is adopted. However, it may be identified by using a different identification method whether the user has already set a policy.

At step 303, policy items are read from the policy item DB 111 and a menu for setting a policy is displayed. At step 304, a user policy is acquired by accepting user's input of setting contents from the menu.

At step 305, contents of the acquired user policy are checked to determine whether there is a contradiction. If there is not a contradiction, the processing proceeds to step 306. If there is not a contradiction, the processing proceeds to step 308.

At step 306, “1” is set in a registration identifier corresponding to the user ID in the user policy DB 112. At step 307, the acquired user policy is preserved in the user policy DB 112. At step 308, an error message indicating that there is a contradiction is displayed and the processing returns to the step 303.

On the other hand, at step 309, an input indicating whether the policy update should be conducted for a user who has already set the policy is accepted. If an input indicating that the update should be conducted is accepted, the processing proceeds to the step 303 and processing similar to that described above is conducted. If an input indicating that the update should not be conducted is accepted, the processing proceeds to the step 310. At the step 310, a user policy already set is read out from the user policy DB 112.

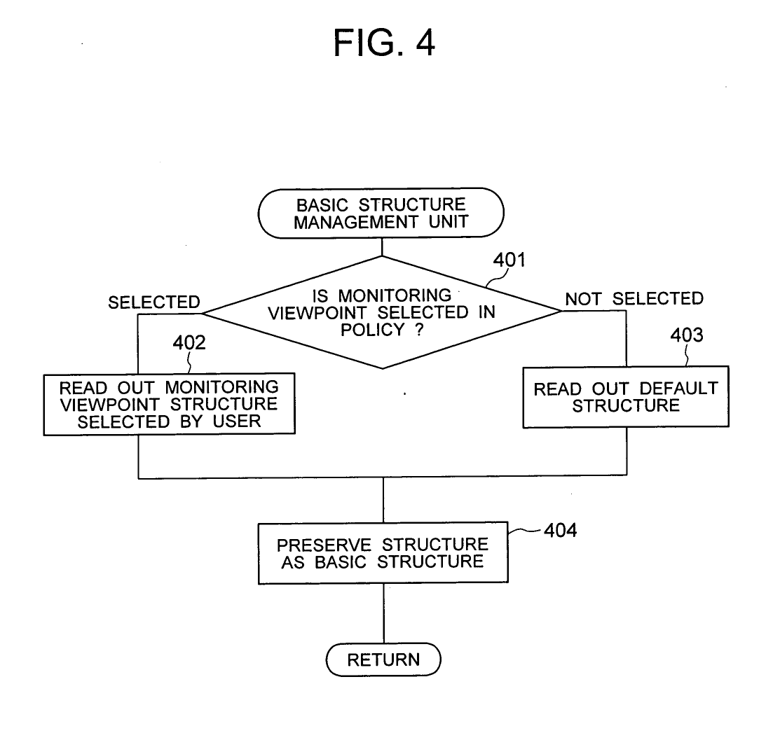

FIG. 4 is a flow chart showing a processing procedure in the basic structure management unit 102 according to the present embodiment. At step 401, the basic structure management unit 102 determines whether the monitoring viewpoint is being handled as a policy item by referring to the policy item DB 111. If the monitoring viewpoint is being handled as a policy item, the processing proceeds to step 402. If the monitoring viewpoint is not being handled as a policy item, the processing proceeds to step 403.

At the step 402, a structure of a monitoring viewpoint set by the user is read out from the user policy DB 112. At the step 403, a structure of a monitoring viewpoint set as a default structure is read out. At step 404, the structure of the monitoring viewpoint thus read out is preserved in the basic structure DB 113 as a basic structure for monitoring the programs and system resources.

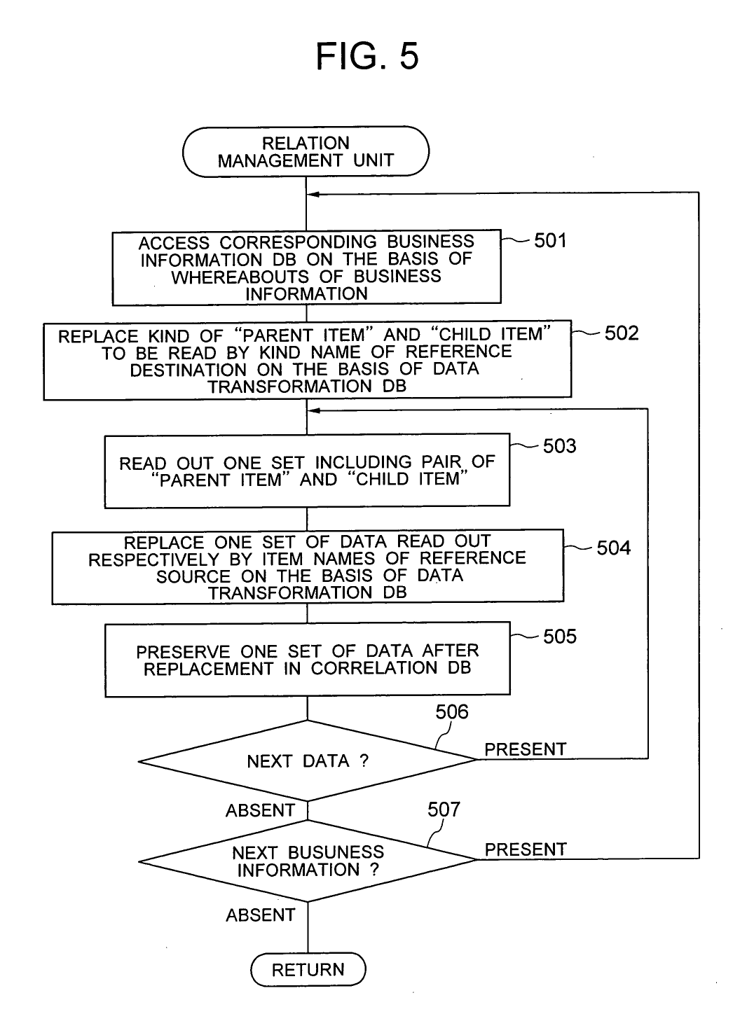

FIG. 5 is a flow chart showing a processing procedure in the relation management unit 103 according to the present embodiment. At step 501, the relation management unit 103 issues a processing request to the business information acquisition unit 121 in a business computer 120 indicated by whereabouts of business information in the configuration information management DB 114, and access the business information DB 123 in the business computer 120, which indicates programs and system resources used in processing in the business processing unit 122 in the business computer 120.

At step 502, a kind name of a reference source of the “parent item” and “child item” to be read is replaced by a kind name of a reference destination on the basis of the data transformation DB 115. Subsequently, at step 503, the business information DB 123 is accessed by using the replaced kind name of the reference destination, and one set including a pair of “parent item” and “child item” is read out from the business information DB 123.

At step 504, data of the set read out are replaced respectively by item names of the reference source on the basis of the data transformation DB 115. Subsequently, at step 505, one set of data replaced by the item names of the reference destination is preserved in the correlation DB 116.

At step 506, it is determined whether the next data is present in the business information DB 123. If the next data is present, the processing returns to the step 503. If the next data is not present, the processing proceeds to step 507. At the step 507, it is determined whether information indicating whereabouts of the next business information is in the configuration information management DB 114. If whereabouts information of the next business information is present, the processing returns to the step 501.

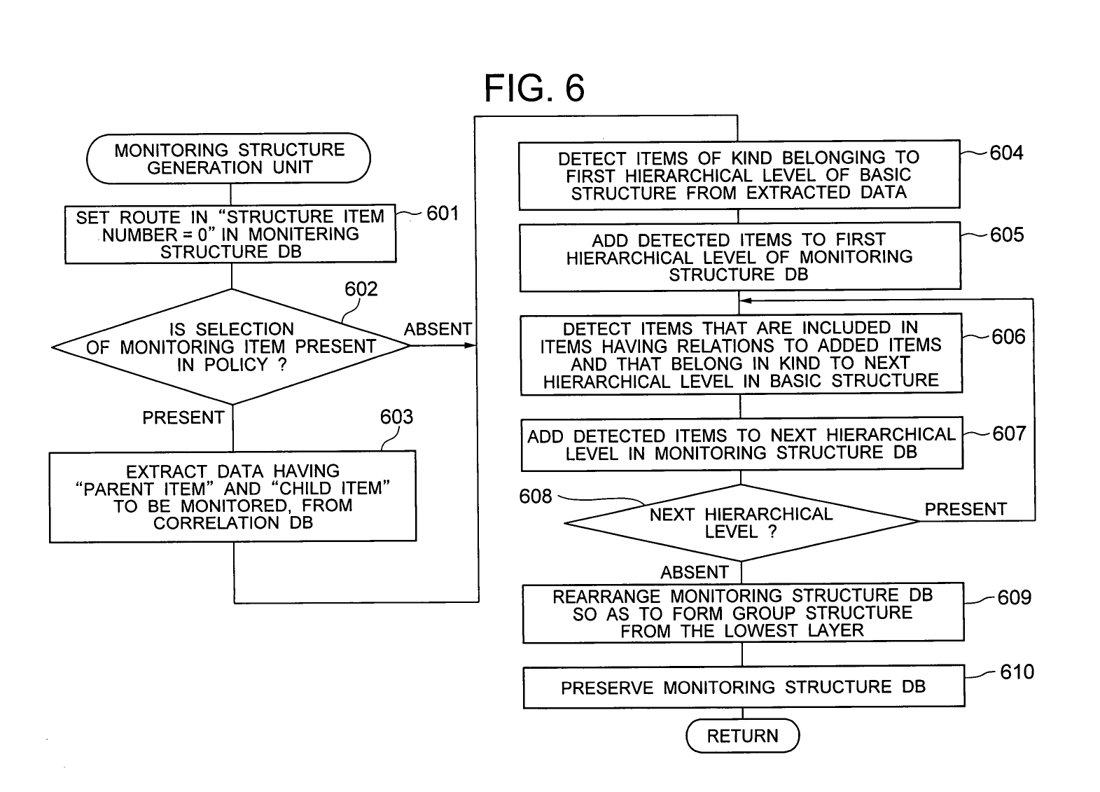

FIG. 6 is a flow chart showing a processing procedure showing in the monitoring structure generation unit 104 according to the present embodiment. At step 601, the monitoring structure generation first sets “root” in an item name of a record of a structure item number “0” corresponding to the user ID in the monitoring structure DB 117.

At step 602, the policy item DB 111 is referenced to determine whether the monitoring item is handled as a policy item. If the monitoring item is handled as a policy item, the processing proceeds to step 603. If the monitoring item is not handled as a policy item, the processing proceeds to step 604.

At the step 603, data having “parent item” and “child item” to be monitored are extracted from the correlation DB 116. Subsequently, at the step 604, items of a kind belonging to a first hierarchical level in the basic structure which has been set are detected from the extracted data. At step 605, the detected items are added to the first hierarchical level in the monitoring structure DB 117.

At step 606, items that are included in items having relations to the added items and that belong in kind to the next hierarchical level in the basic structure are extracted from the extracted data. At step 607, the detected items are added to the next hierarchical level in the monitoring structure DB 117.

At step 608, it is determined by referring to the base structure whether the next hierarchical level is present. If the next hierarchical level is present, the processing returns to the step 606. If the next hierarchical level is not present, the processing proceeds to step 609.

At the step 609, the record in the monitoring structure DB 117 subjected to the addition is temporarily stored on the memory, and rearranged so as to form a group structure from the lowest layer. Subsequently, at step 610, the rearranged record is preserved in the monitoring structure DB 117.

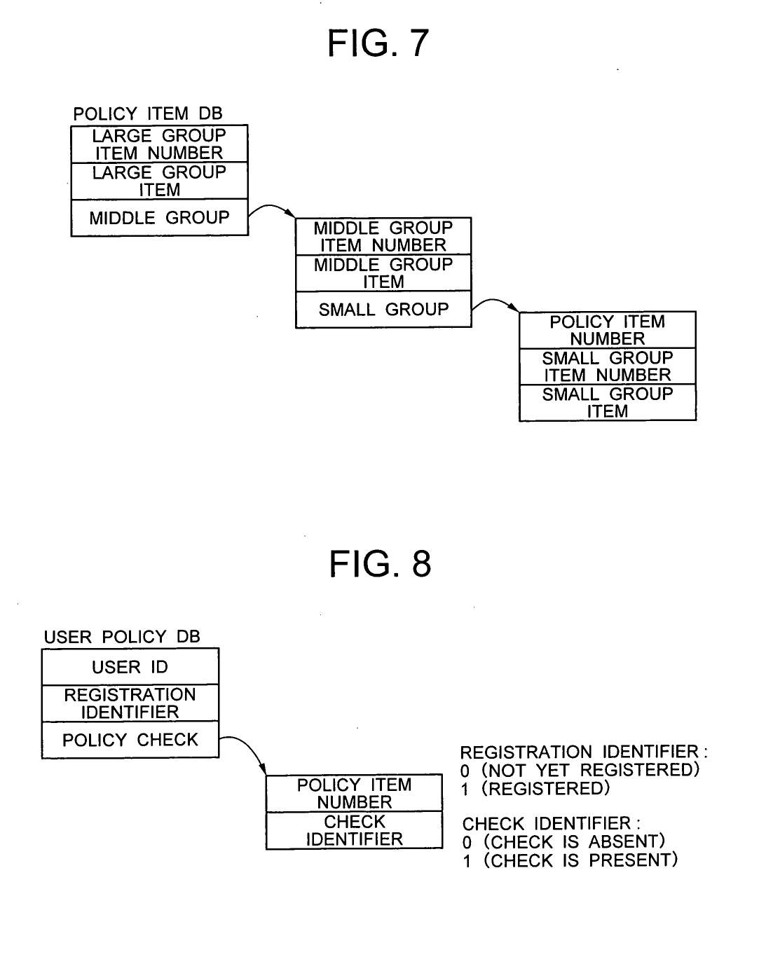

FIG. 7 is a diagram showing a data structure of the policy item DB 111 according to the present embodiment. As shown in FIG. 7, the policy item DB 111 according to the present embodiment has a data structure for storing a large class item number indicating a number of an item corresponding to a large class and a large class item indicating an item name, storing, as information of a middle class located under a large class, a middle class item number indicating a number of an item corresponding to the middle class and a middle class item indicating its item name, and storing, as information of a small class located under a middle class, a policy item number indicating a number of the policy item, a small class item number and a small class item.

FIG. 8 is a diagram showing a data structure of a user policy DB 112 according to the present embodiment. As shown in FIG. 8, the user policy DB 112 according to the present embodiment has a data structure that stores a user ID for identifying the user, a registration identifier for indicating whether the user policy has already been registered, and stores, as policy check information indicating selected contents of the policy, a policy item number indicating a number of a policy item and a check identifier for indicating whether the policy item has been selected by the user.

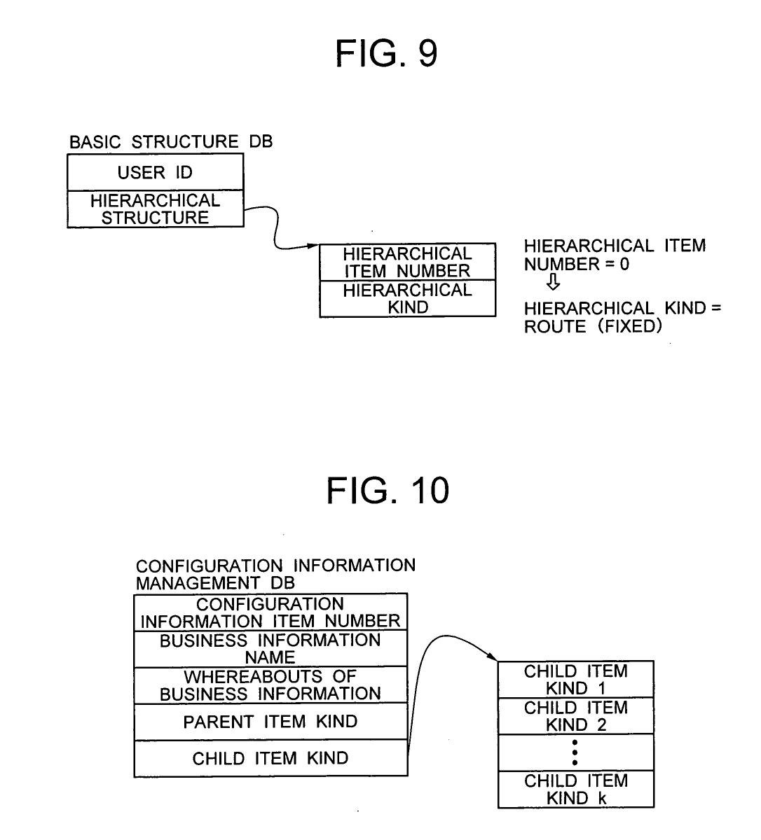

FIG. 9 is a diagram showing a data structure of the basic structure DB 113 according to the present embodiment. As shown in FIG. 9, the basic structure DB 113 has a data structure that stores a user ID for identifying the user, and stores, as information indicating the hierarchical structure, a hierarchical item number indicating a number for identifying a hierarchical level and a hierarchical kind indicating a kind of the hierarchical level.

FIG. 10 is a diagram showing a data structure of the configuration information management DB 114 according to the present embodiment. As shown in FIG. 10, the configuration information management DB 114 of the present embodiment has a data structure that stores a configuration information item number indicating a number of configuration information, a business information name indicating a name of business information corresponding to the item number, whereabouts of business information indicating whereabouts of business information corresponding to the item number, and a parent item kind indicating a kind name in reference source of a parent item of business information corresponding to the item number, and that stores, as a child item kind indicating a kind name of the child item, child item kinds 1 to k indicating kind names in reference source of a child item of business information corresponding to the item number.

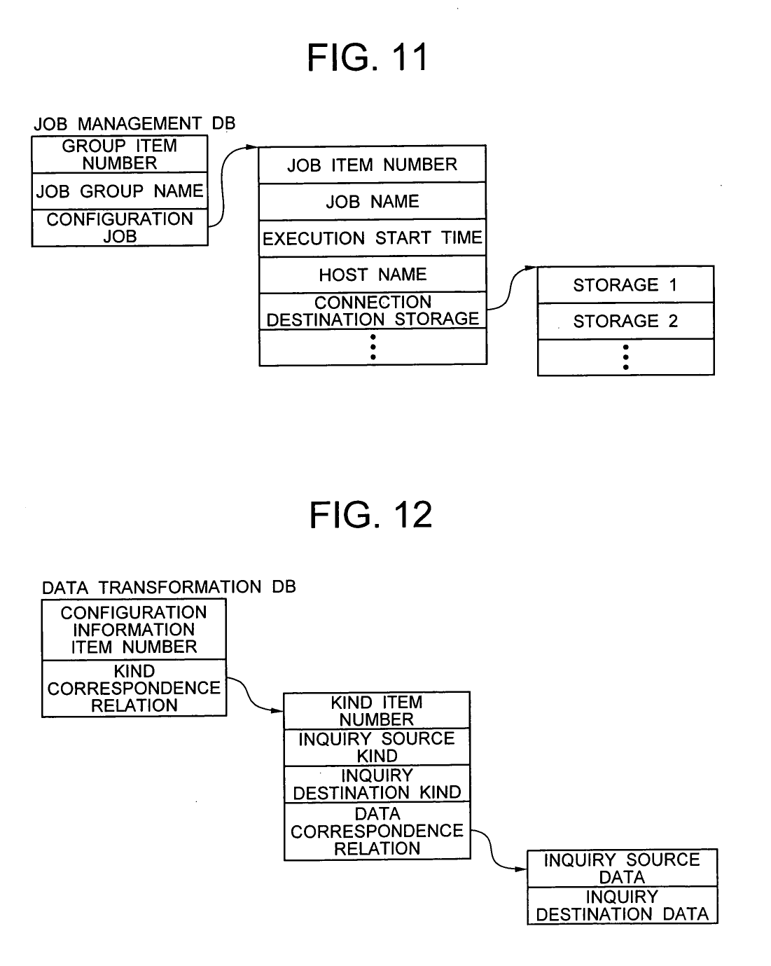

FIG. 11 is a diagram showing a data structure of a job management DB, which is included in the business information DB 123, according to the present embodiment. As shown in FIG. 11, the job management DB, which is included in the business information DB 123, according to the present embodiment has a data structure that stores a group item number indicating a number of a job group, and a job group name indicating a name of the job group having the item number, stores, as information of a configuration job formed by the job group having the item number, a job item number indicating a number of the job, a job name indicating a name of the job having the item number, an execution start time indicating the time when execution of the job having the item number is started, and a host name indicating a name of a host that executes the job having the item number, and stores, as information of connection destination storages connected at the time of execution of the job having the item number, storages 1 and 2 indicating names of connection destination storages.

By the way, the individual business information DB 123 does not necessarily have the same data structure as the job management DB shown in FIG. 11. Typically, the individual business information DBs 123 have different structures, respectively. The data structure of the business information DB 123 included in each business computer is grasped by the business information acquisition unit 121. The business information acquisition unit 121 has a function of responding to an inquiry request of “parent item” and “child item” issued as a result of processing conducted by the relation management unit 103, acquiring corresponding data on the basis of the structure of the business information DB 123, and providing the relation management unit 103 with the corresponding data.

FIG. 12 is a diagram showing a data structure of the data transformation DB 115 according to the present embodiment. As shown in FIG. 12, the data transformation DB 115 has a structure that stores a configuration information item number indicating a number of configuration information, stores, as information of a kind correspondence relation indicating a correspondence relation in kind of configuration information having the item number between the inquiry source and the inquiry destination, a kind item number indicating a number of a kind, an inquiry source kind indicating a kind name at an inquiry source, and an inquiry destination kind indicating a kind name at an inquiry destination, and stores, as information of a data correspondence relation indicating a correspondence relation in data of configuration information having the item number between the inquiry source and the inquiry destination, inquiry source data indicating a data name at the inquiry source and inquiry destination data indicating a data name at the inquiry destination.

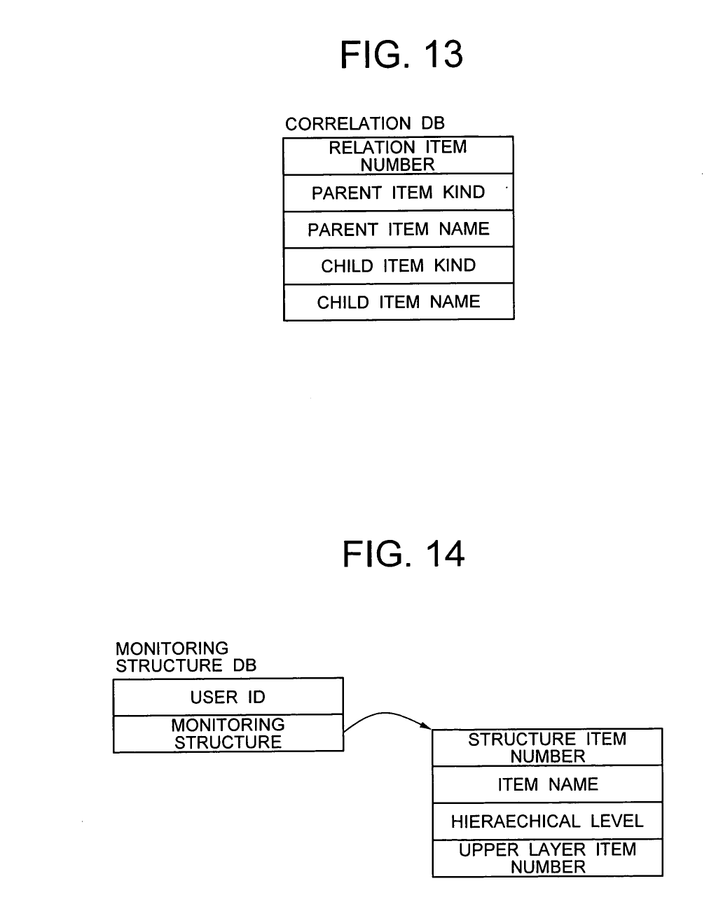

FIG. 13 is a diagram showing a data structure of the correlation DB 116 according to the present embodiment. As shown in FIG. 13, the correlation DB 116 according to the present embodiment has a data structure for storing a relation item number indicating a number of correlation, a parent item kind indicating a kind name of a parent item in the correlation having the item number, a parent item name indicating an item name of a parent item in the correlation having the item number, a child item kind indicating a kind name of a child item for the parent item, and a child item name indicating an item name of a child item for the parent item.

FIG. 14 is a diagram showing a data structure of the monitoring structure DB 117 according to the present embodiment. As shown in FIG. 14, the monitoring structure DB 117 according to the present embodiment has a data structure that stores a user ID for identifying the user, and stores, as information of a monitoring structure of the user having the user ID, a structure item number indicating a number of the monitoring structure, an item name indicating a name of a monitoring item corresponding to the item number, a hierarchical level indicating a location of an item having the item number in the monitoring structure, and an upper layer item number indicating a structure item number of “parent item” data corresponding to the item having the item number.

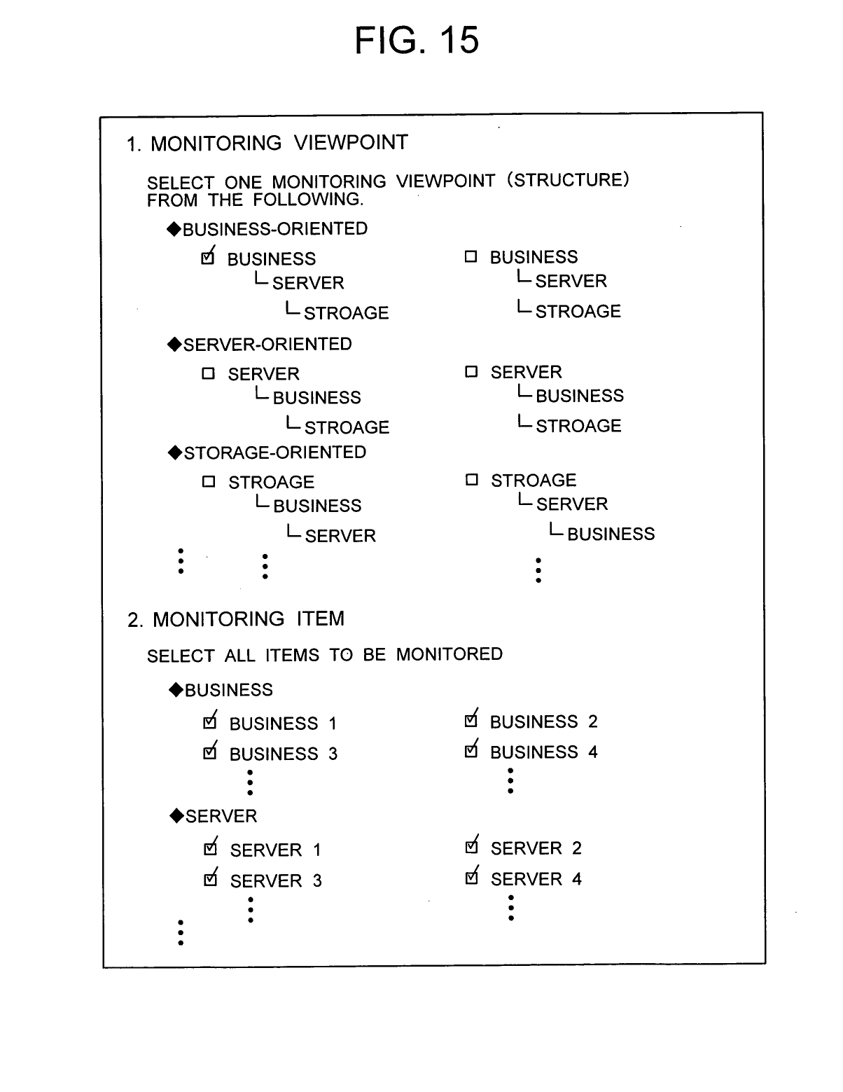

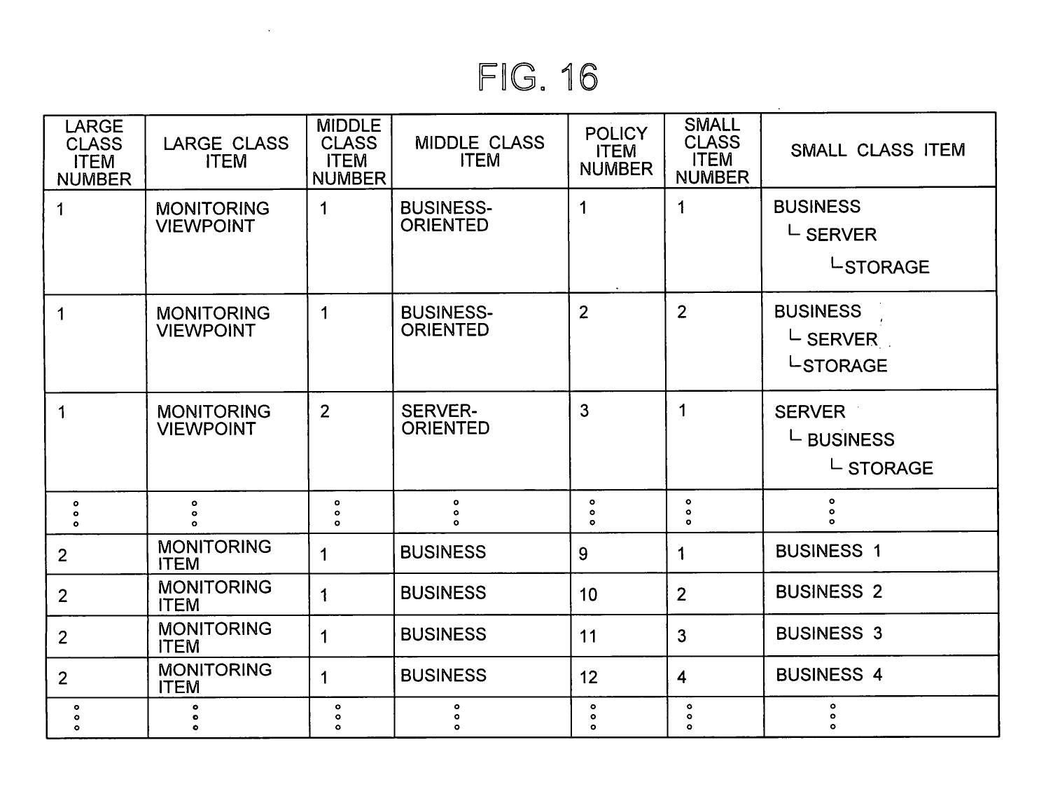

FIG. 15 is a diagram showing a policy setting view according to the present embodiment. As shown in FIG. 15, a menu for selecting a monitoring viewpoint (structure) such as “business-oriented,” “server-oriented” or “storage-oriented,” and a monitoring item such as a business or a server is displayed on the policy setting view according to the present embodiment. In the present embodiment, the user can select a policy item by inputting a check into the menu. However, a user policy setting method according to another embodiment may also be used.

FIG. 16 is a diagram showing an example of the policy item DB 111 according to the present embodiment. In the policy item DB 111 shown in FIG. 16, for example, an example in which a large class item number “1,” a large class item “monitoring viewpoint,” a middle class item number “1,” a middle class item “business-oriented,” a policy item number “1,” a small class item number “1,” and a small class item “basic structure of business—server—storage” are stored is represented.

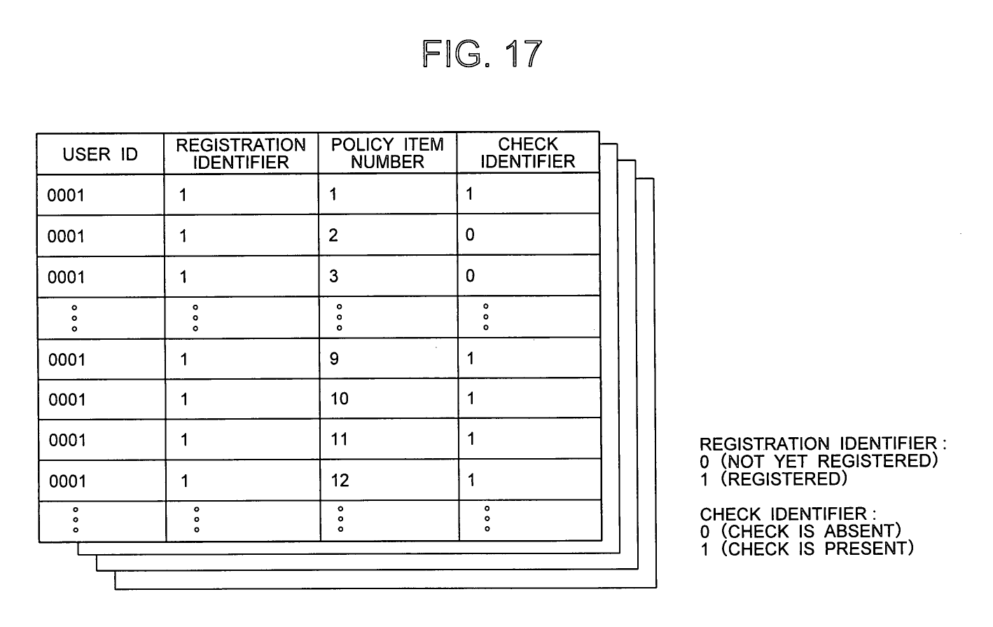

FIG. 17 is a diagram showing an example of the user policy DB 112 according to the present embodiment. In the user policy DB 112 shown in FIG. 17, for example, an example in which a user ID “0001,” a registration identifier “1,” a policy item number “1” and a check identifier “1” is represented.

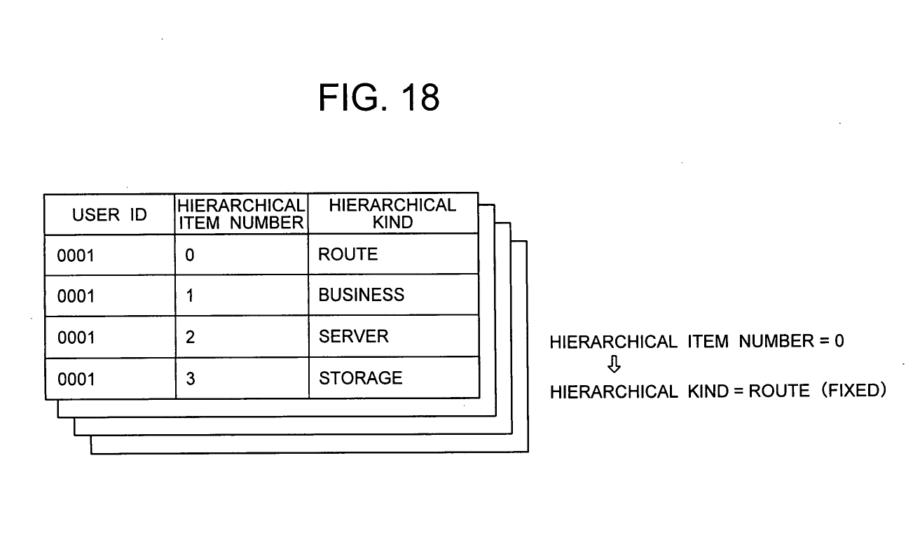

FIG. 18 is a diagram showing an example of the basic structure DB 113. In the basic structure DB 113 shown in FIG. 18, for example, an example in which a user ID “0001,” a hierarchical item number “0” and a hierarchical kind “root” is represented.

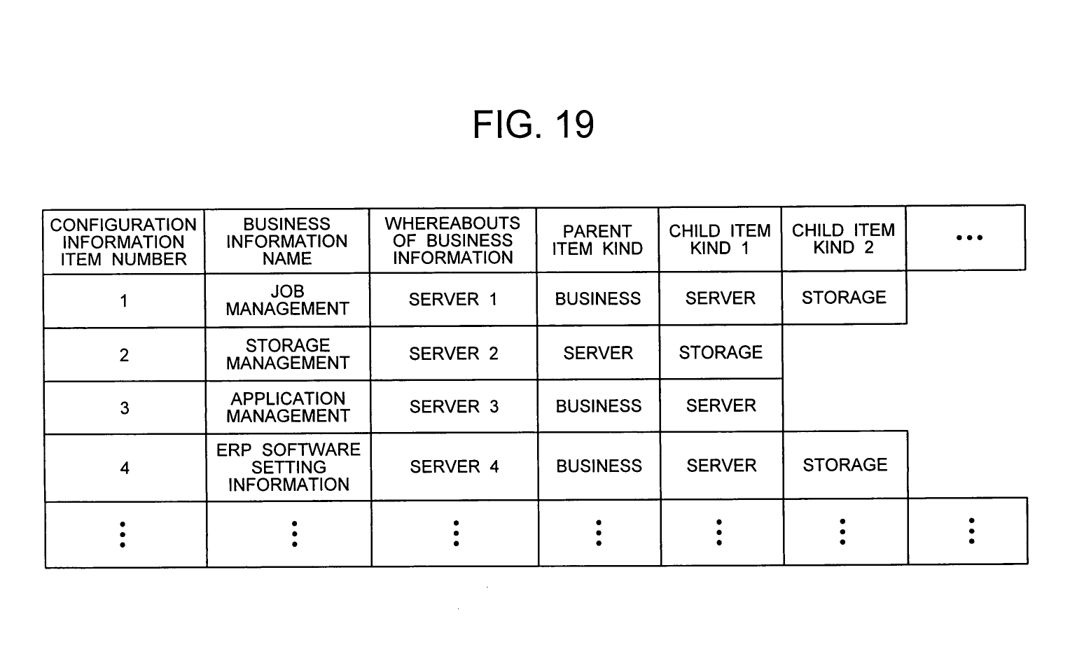

FIG. 19 is a diagram showing an example of the configuration information management DB 114 according to the present embodiment. In the configuration information management DB 114 shown in FIG. 19, for example, an example in which a configuration information item number “1,” a business information name “job management,” whereabouts of business information “server 1,” a parent item kind “business” and a child item kind “server” and “storage” are stored is represented.

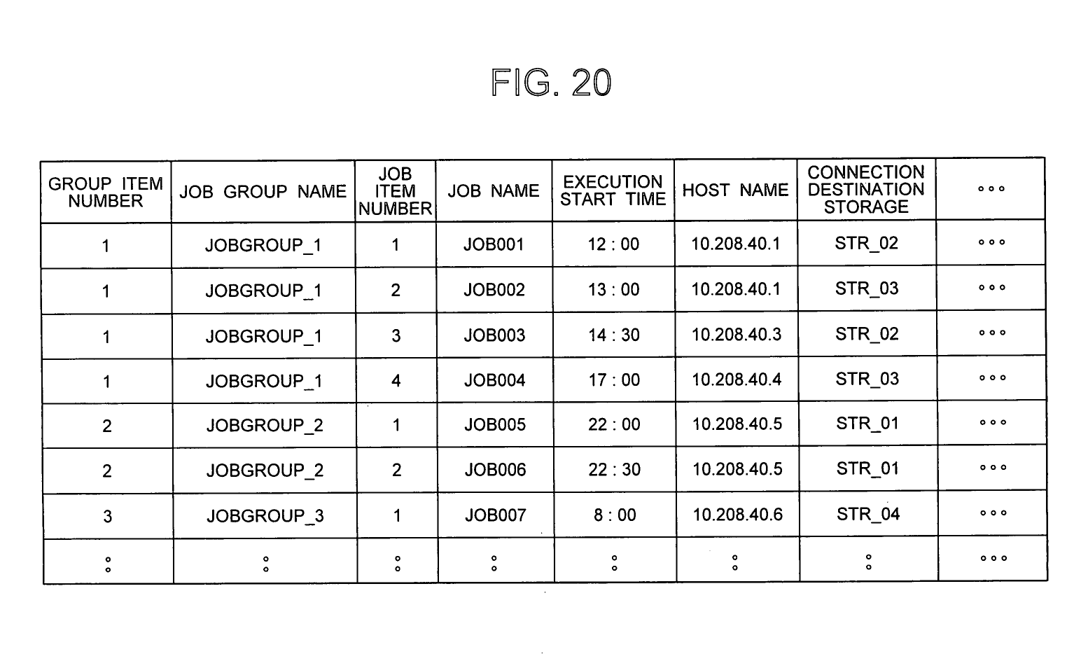

FIG. 20 is a diagram showing an example of the job management DB as an example of the business information DB 123 according to the present embodiment. In the job management DB included in the business information DB 123 shown in FIG. 20. for example, an example in which a group item number “1,” a job group name “JOBGROUP_{—}1,” a job item number “1,” a job name “Job001,” an execution start time “12:00,” a host name “10.208.40.1” and a connection destination storage “STR_{—}02” are stored is represented.

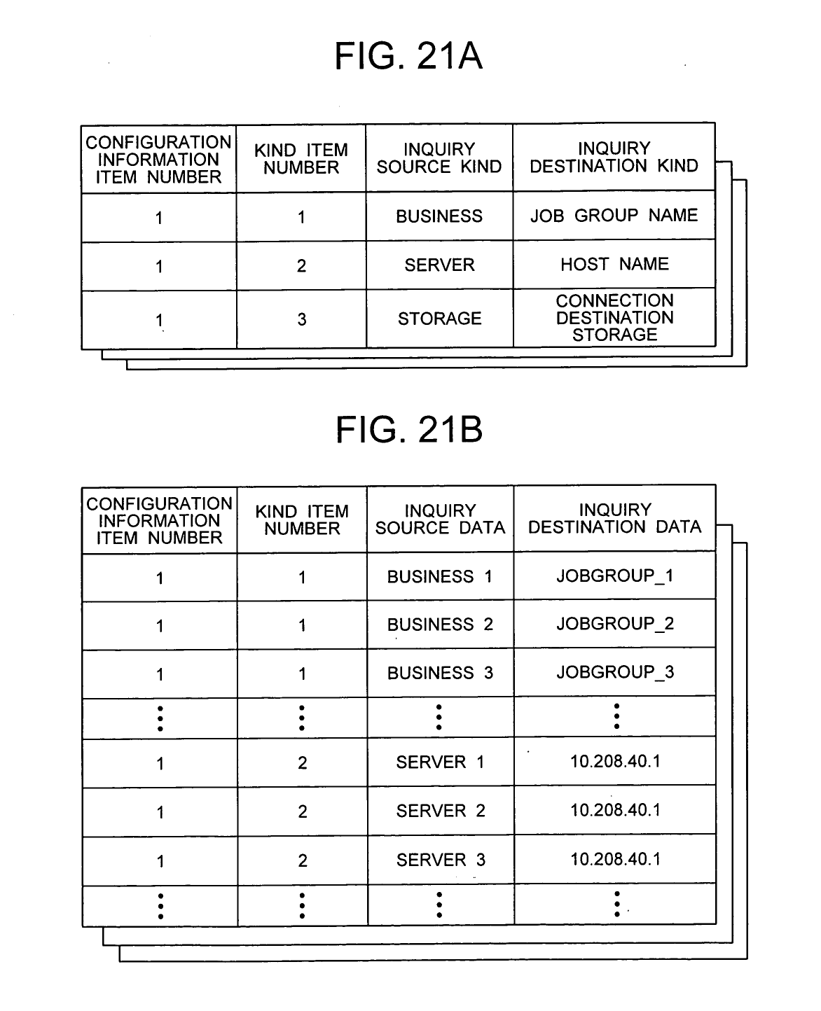

FIGS. 21A and 21B are diagrams showing an example of the data transformation DB 115 according to the present embodiment. In the data transformation DB 115 shown in FIGS. 21A and 21B, for example, an example in which a configuration information item number “1,” a kind item number “1,” an inquiry source kind “business,” an inquiry destination kind “job group name,” inquiry source data “business 1” and inquiry destination data “JOBGROUP_{—}1” is represented.

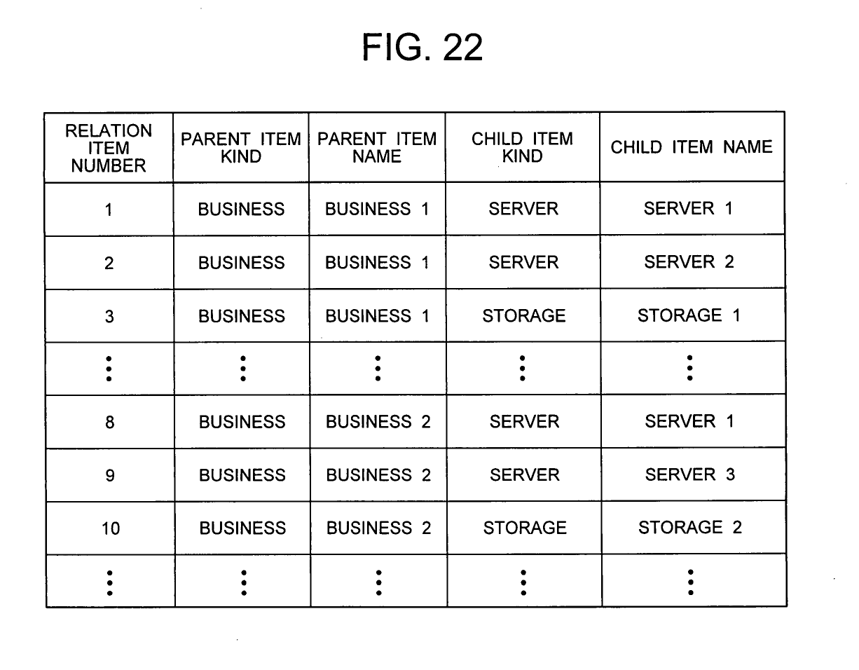

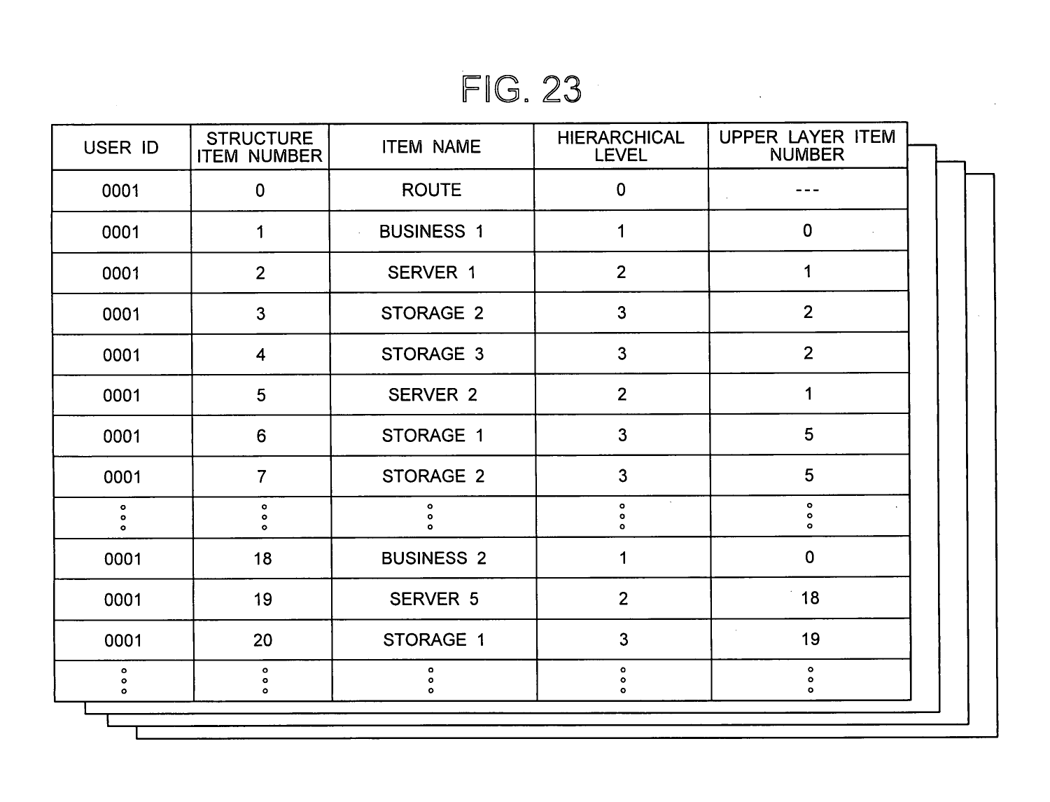

FIG. 22 is a diagram showing an example of the correlation DB 116 according to the present embodiment. In the correlation DB 116 shown in FIG. 23, for example, an example in which a relation item number “1,” a parent item kind “business,” a parent item name “business 1,” a child item kind “server” and a child item name “server 1” is represented.

FIG. 23 is a diagram showing an example of the monitoring structure DB 117 according to the present embodiment. In the monitoring structure DB 117 shown in FIG. 23, for example, an example in which a user ID “0001,” a structure item number “0,” an item name “root,” a hierarchical level 20,” and an upper layer item number “- - - ” are stored is represented.

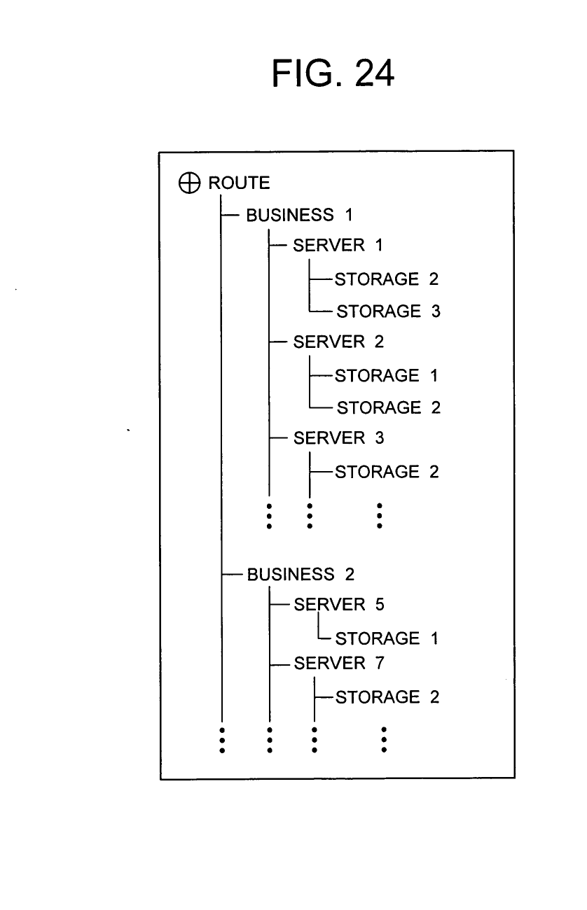

FIG. 24 is a diagram showing a display example of the monitoring tree as an example of the monitoring structure, which is the final product, according to the present embodiment. In the monitoring tree shown in FIG. 24, a display example in the case where the monitoring structure example shown in FIG. 23 is displayed as a monitoring tree is represented. In the business-oriented basic structure selected in the policy setting example shown in FIG. 15 by the user, a monitoring tree for monitoring business, servers and storages in the business computers is formed in the order of the business 1, the server 1 and the storage 2 and the like.

As described above, the performance management system according to the present embodiment replaces the business information DB 123 indicating the programs and system resources used in each business computer 120 by information stored in the data transformation DB 115, finds correlations, and generates the monitoring structure information for monitoring the programs and system resources. Therefore, it is possible to efficiently generate a monitoring structure according to the viewpoint the user desires and the item the user desires to monitor, from the business information DB 123 prepared for business processing in each business computer 120.

Furthermore, the performance management system according to the present embodiment collects necessary information from business computers on the system on the basis of a policy selected by each user, and generates a monitoring structure (for example, a monitoring tree) conforming to the user's needs. Therefore, it is possible to efficiently generate a monitoring structure according to the viewpoint the user desires and the item the user desires to monitor.

As heretofore described, in the performance management system according to the present embodiment, monitoring structure information for monitoring programs and system resources is generated from business information representing programs and system resources used in the computers. Therefore, it is possible to efficiently generate monitoring structure information that represents various structures such as a monitoring structure relating a program to a specific system resource and a monitoring structure relating the specific system resource to another system resource.

### Second Embodiment

Hereafter, a performance management system according to a second embodiment, which alters a policy menu every user according to the type of industry and authority, will be described.

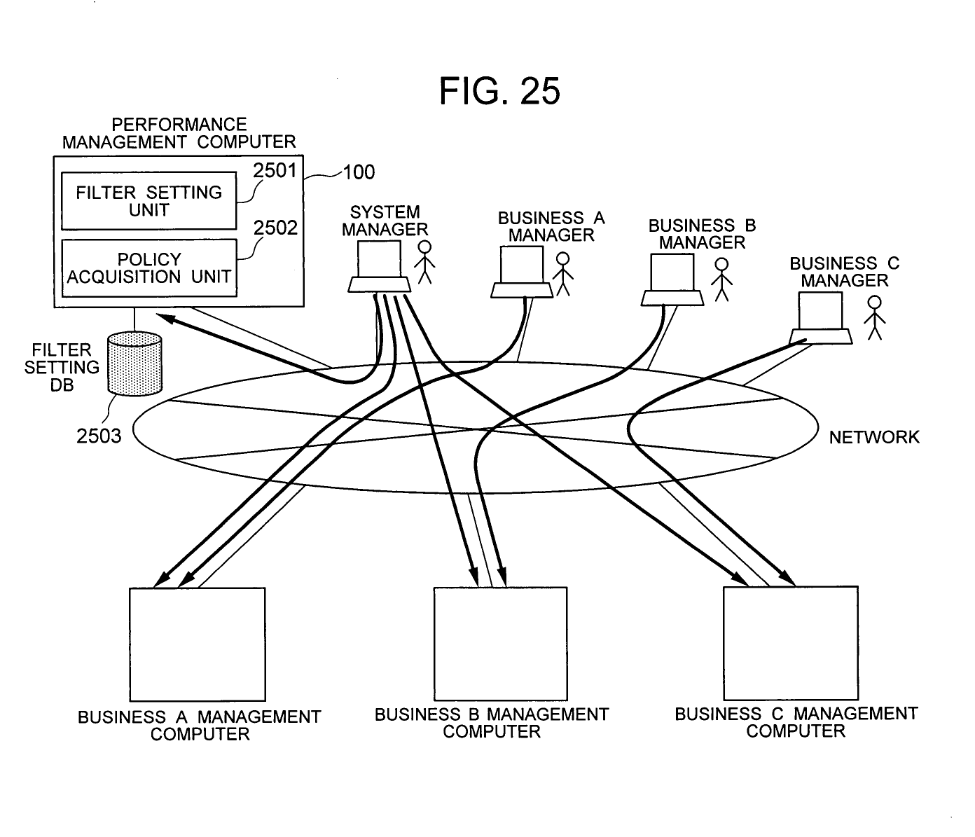

FIG. 25 is a diagram showing a schematic configuration of a performance management system according to the present embodiment. In other words, a configuration in which a manager of business A can refer to only items concerning the business A is shown. The same holds true for managers of business B and business C as well. In other words, each business manager cannot refer to items other than the own business. In addition, which business manager can access which business management computer is set by a system administrator. As shown in FIG. 25, a performance management computer 100 according to the present embodiment includes a filter setting unit 2501 and a policy acquisition unit 2502.

The filter setting unit 2501 is a processing unit that sets filter information in a filter setting DB 2503 in order to alter, every user, contents of a menu for selecting a policy. The policy acquisition unit 2502 is a processing unit for acquiring a policy selected by the user from a menu filtered according to filter information stored in the filter setting DB 2503.

A program for causing the performance management computer 100 to function as the filter setting unit 2501 and the policy acquisition unit 2502 is recorded on a media such as a CD-ROM and stored on a magnetic disk or the like, and thereafter loaded in a memory and executed. The media for recording the program thereon may be a media other than the CD-ROM. The program may be installed from the media into an information processing apparatus. Or the program may be used by accessing the media via the network.

Each of other processing units in the present embodiment has a configuration similar to that in the first embodiment.

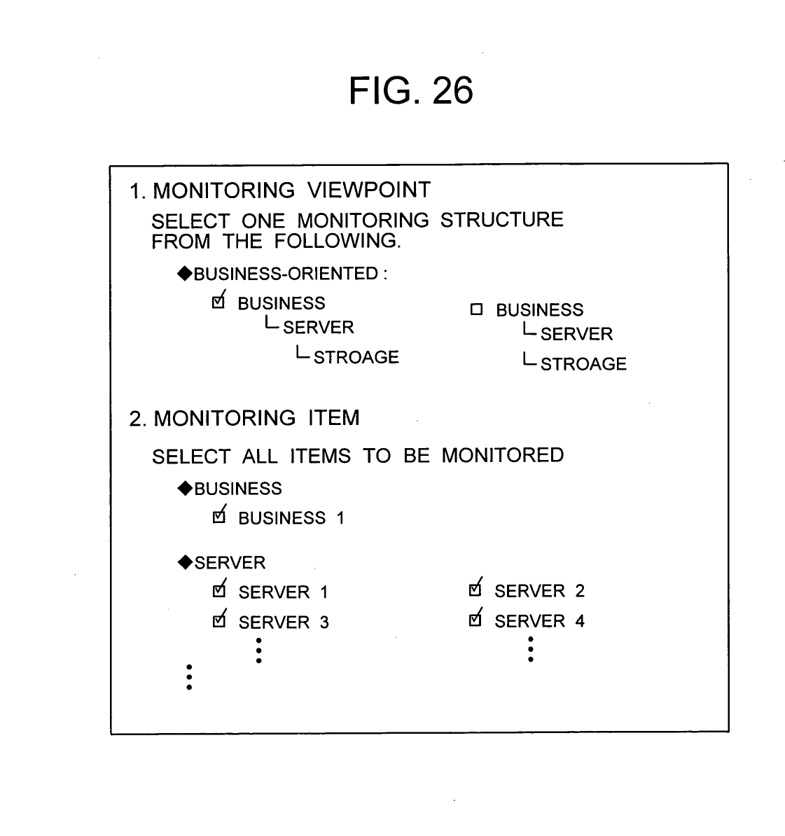

FIG. 26 is a diagram showing an example of a policy setting view at the time of filtering execution in the present embodiment. As shown in FIG. 26, a menu for selecting only “business-oriented” as the monitoring viewpoint and only “business 1” as business of the monitoring item is displayed in the policy setting view of the present embodiment. In this example, the “server-oriented” and “storage-oriented” in the monitoring viewpoint, and business 2, business 3 and so on in the monitoring item are filtered in the example shown in FIG. 15.

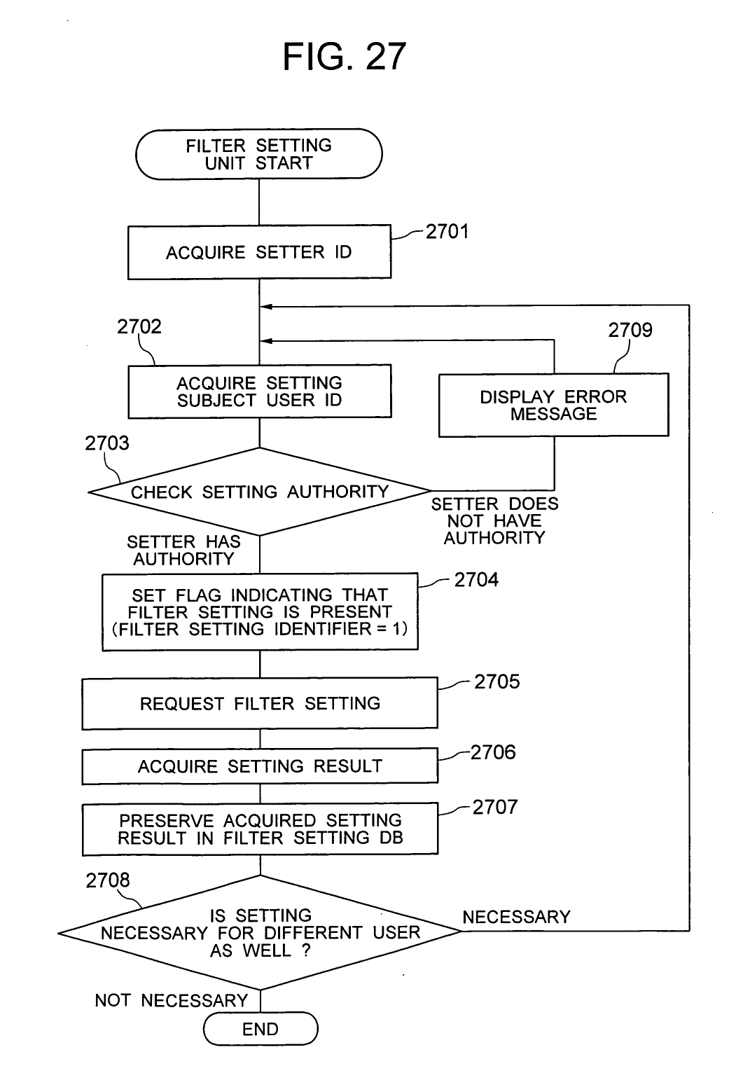

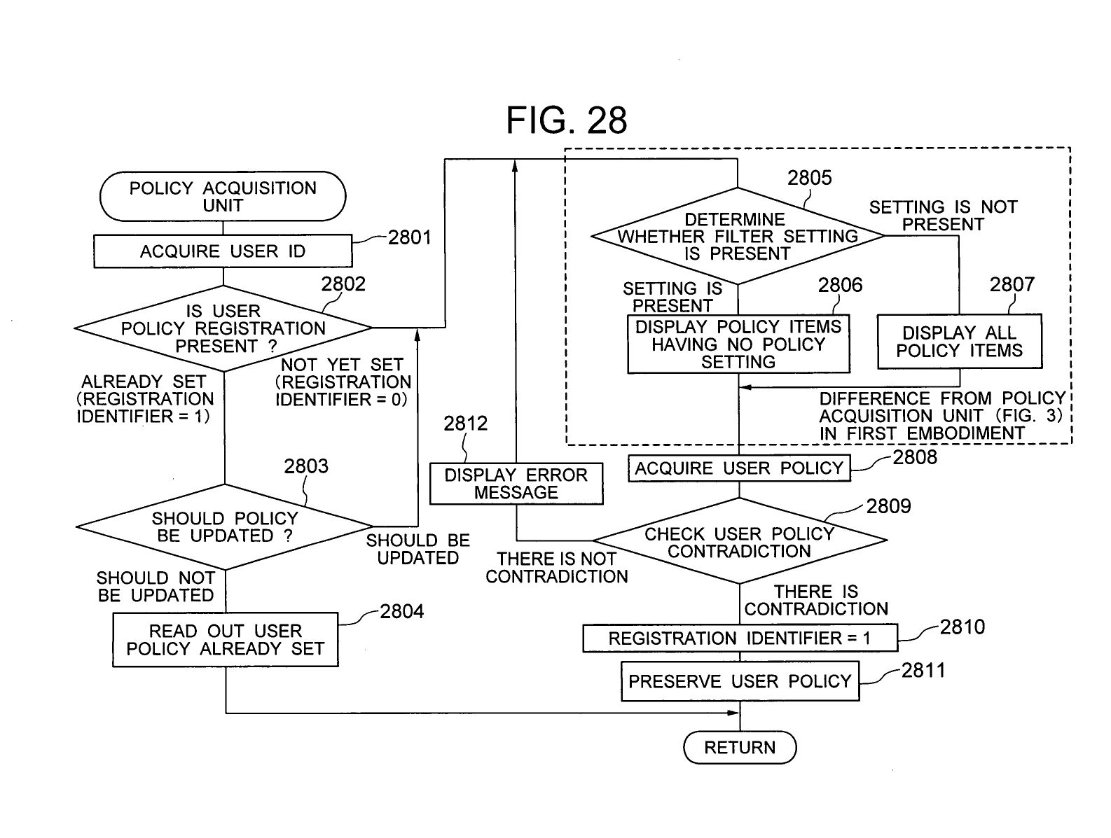

FIG. 27 is a flow chart showing a processing procedure in the filter setting unit 2501 according to the present embodiment. At step 2701, the filter setting unit 2501 acquires a setter ID for identifying a setter who sets filter information. At step 2702, the filter setting unit 2501 acquires a setting subject user ID for identifying a user for whom filter setting is conducted.

At step 2703, it is determined whether the setter identified by the setter ID has authority for filter setting for the setting subject user. If the setter has authority for filter setting, the processing proceeds to step 2704. If the setter does not have authority for filter setting, then the processing proceeds to step 2709, where an error message indicating that the setter does not have authority is displayed.

At the step 2704, “1” is set in a filter setting identifier of the setting subject user ID, as flag setting indicating that filter setting is present. At step 2705, the setter is requested to input filter setting. At step 2706, a result of filter information setting input by the setter is acquired.

By the way, the filter setting identifier is an identifier for identifying whether filter setting is conducted for the user. In the present embodiment, a method of identifying whether the filter setting is registered or not registered by whether the filter setting identifier is “1” or “0” is adopted. However, a different identifying method may also be adopted.

At step 2707, the setting subject user ID, the set filter setting identifier, and the acquired filter information setting contents are preserved in the filter setting DB 2503.

At step 2708, it is determined whether there is an input indicating that filter information should be set for a different user. If there is an input indicating that filter information should be set for a different user as well, the processing returns to the step 2702. If there is an input indicating that filter information should not be set for a different user, the processing is finished.

FIG. 28 is a flow chart showing a processing procedure in the policy acquisition unit 2502 according to the present embodiment. At step 2801, the policy acquisition unit 2502 acquires a user ID for identifying a user for whom policy acquisition is conducted.

At step 2802, a registration identifier corresponding to the acquired user ID is read out by referring to the user policy DB 112, and it is determined whether registration of the user policy is present by checking whether “1” is set in the registration identifier. If the user policy is not yet set, the processing proceeds to step 2805. If the user policy is already set, the processing proceeds to step 2803.

At the step 2803, an input indicating whether the policy should be updated is accepted. If an input indicating that the policy should be updated is accepted, the processing proceeds to the step 2805. If an input indicating that the policy should not be updated is accepted, the processing proceeds to the step 2804. At the step 2804, the user policy already set is read out and the processing is finished.

At the step 2805, it is determined by referring to the filter setting identifier in the filter setting DB 2503 whether filter setting for the user is present. If the filter setting is present, the processing proceeds to step 2806. If the filter setting is not present, the processing proceeds to step 2807.

At step 2806, a filter item identifier in the filter setting DB 2503 is referenced and a menu formed of only policy items which are included in the policy items and in which filter setting is not conducted is generated and displayed. At step 2807, a menu including all policy items is generated and displayed.

At step 2808, a user policy is acquired by accepting an input of contents selected by the user from the displayed menu.

At step 2809, contents of the acquired user policy are checked to determine whether there is a contradiction. If there is not a contradiction, the processing proceeds to step 2810. If there is not a contradiction, the processing proceeds to step 2812.

At step 2810, “1” is set in a registration identifier corresponding to the user ID in the user policy DB 112. At step 2811, the acquired user policy is preserved in the user policy DB 112. At step 2812, an error message indicating that there is a contradiction is displayed.

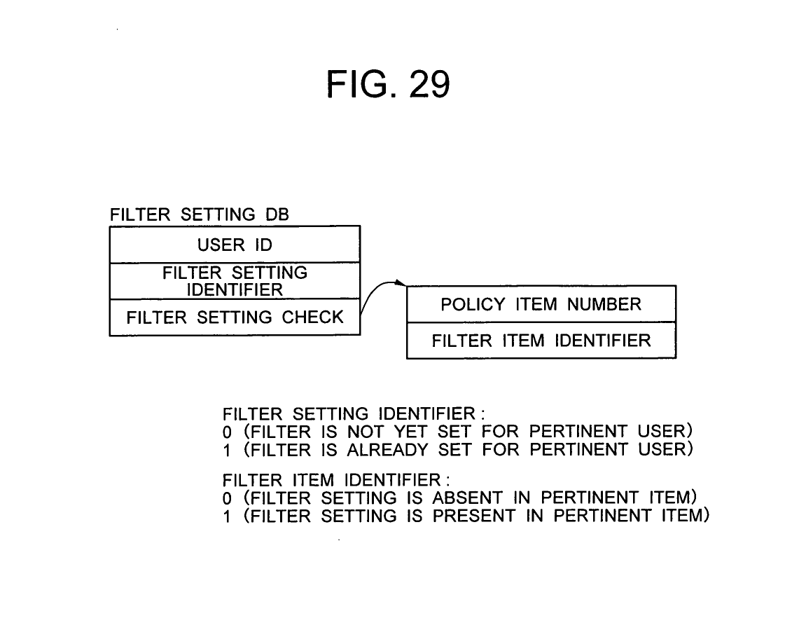

FIG. 29 is a diagram showing a data structure of the filter setting DB 2503 according to the present embodiment. As shown in FIG. 29, the filter setting DB 2503 in the present embodiment has a data structure that stores a user ID for identifying the user and a filter setting identifier indicating whether filter information has been set for the user, and stores, as filter setting check information indicating filter information setting contents, a policy item number indicating a number of a policy item and a filter item identifier indicating whether filter setting has been conducted for the policy item having the item number.

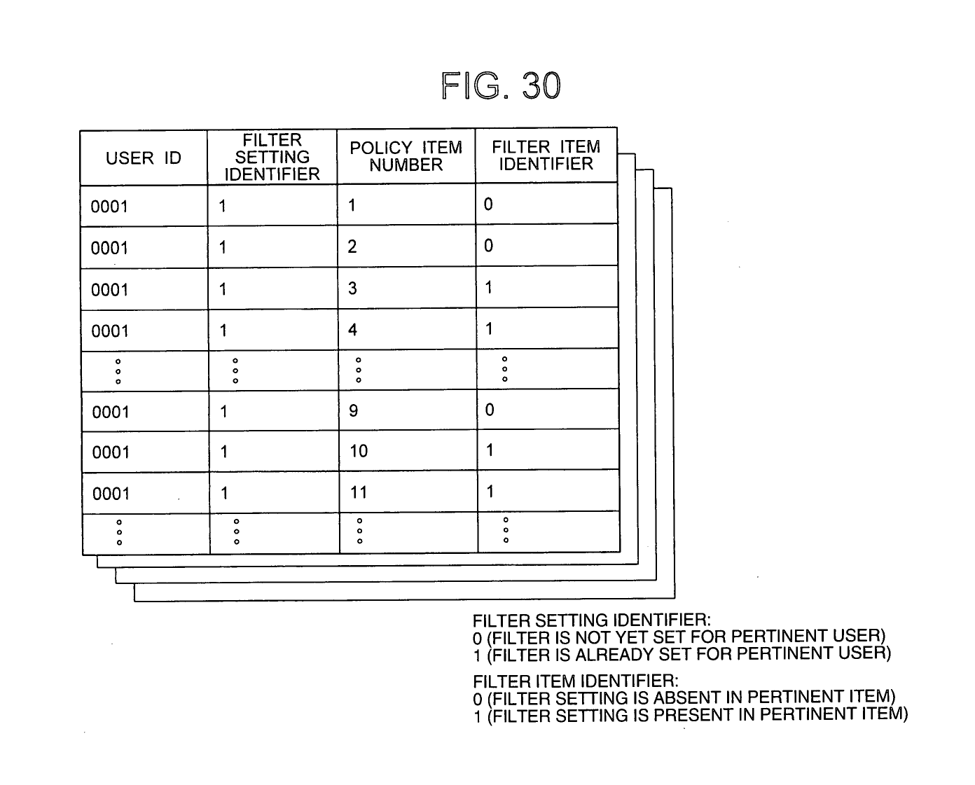

FIG. 30 is a diagram showing an example of the filter setting DB 2503 according to the present embodiment. In the filter setting DB 2503 shown in FIG. 30, for example, an example in which a user ID “0001,” a filter setting identifier “1,” a policy item number “3” and a filter item identifier “1” is represented. It will be appreciated that a filter is set for a user having a user ID “0001” and a policy item having a policy item number “3.”

In the performance management according to the present embodiment, a policy menu is changed from user to user according to the type of industry and authority as described above. This is access control in which the user himself or herself does not filter the monitoring items on the basis of the policy, but a person having authority other than the user (typically a system administrator) previously sets policy items that are not necessary for the user so as not to be displayed.

As heretofore described, according to the performance management in the present embodiment, it becomes possible to prevent access to unnecessary information by altering the contents of the menu for selecting a policy from user to user and thereby keeping items that are not obviously selected by the user and items desired not to be selected by the user from being displayed.

### Third Embodiment

Hereafter, a performance management system according to a third embodiment, which forcibly conducts partial or whole policy setting by using preset contents, will be described.

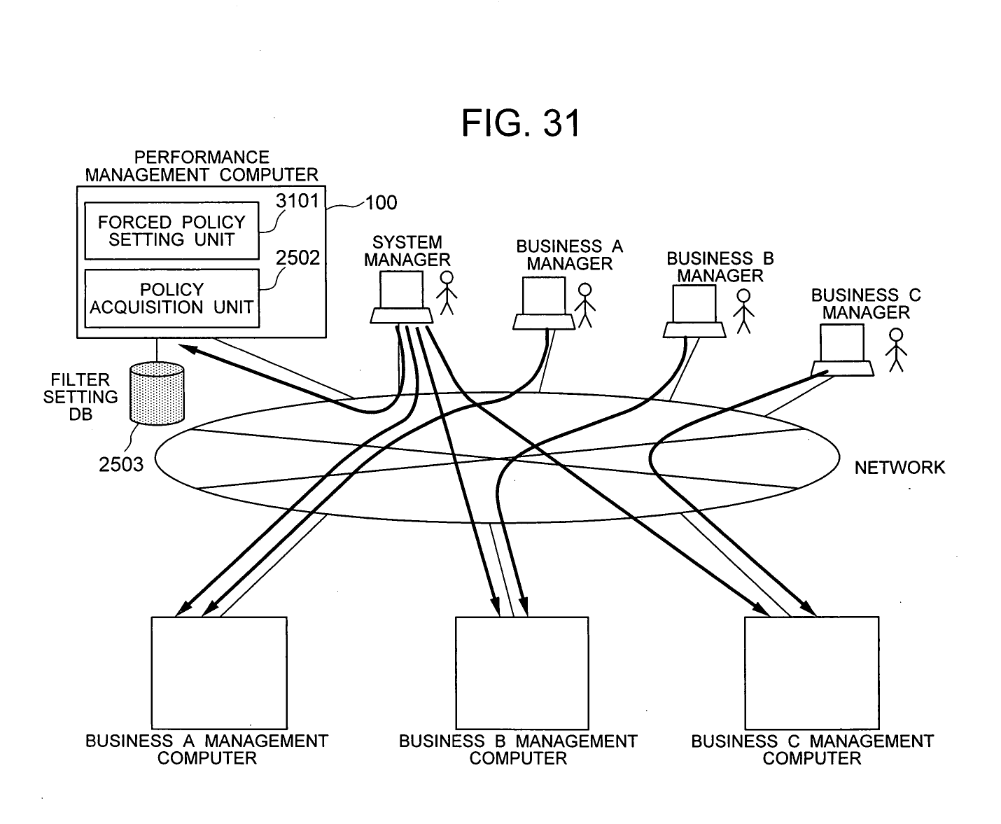

FIG. 31 is a diagram showing a general configuration of a performance management system according to the present embodiment. As shown in FIG. 31, a performance management computer 100 according to the present embodiment includes a forced policy setting unit 3101. The forced policy setting unit 3101 is a processing unit for forcibly conducting partial or whole policy setting by using preset contents.

A program for making the performance management computer 100 function as the forced policy setting unit 3101 is recorded on a media such as a CD-ROM and stored on a magnetic disk or the like, and thereafter loaded in a memory and executed. The media for recording the program thereon may be a media other than the CD-ROM. The program may be installed from the media into an information processing apparatus. Or the program may be used by accessing the media via the network.

Each of other processing units in the present embodiment has a configuration similar to that in the second embodiment.

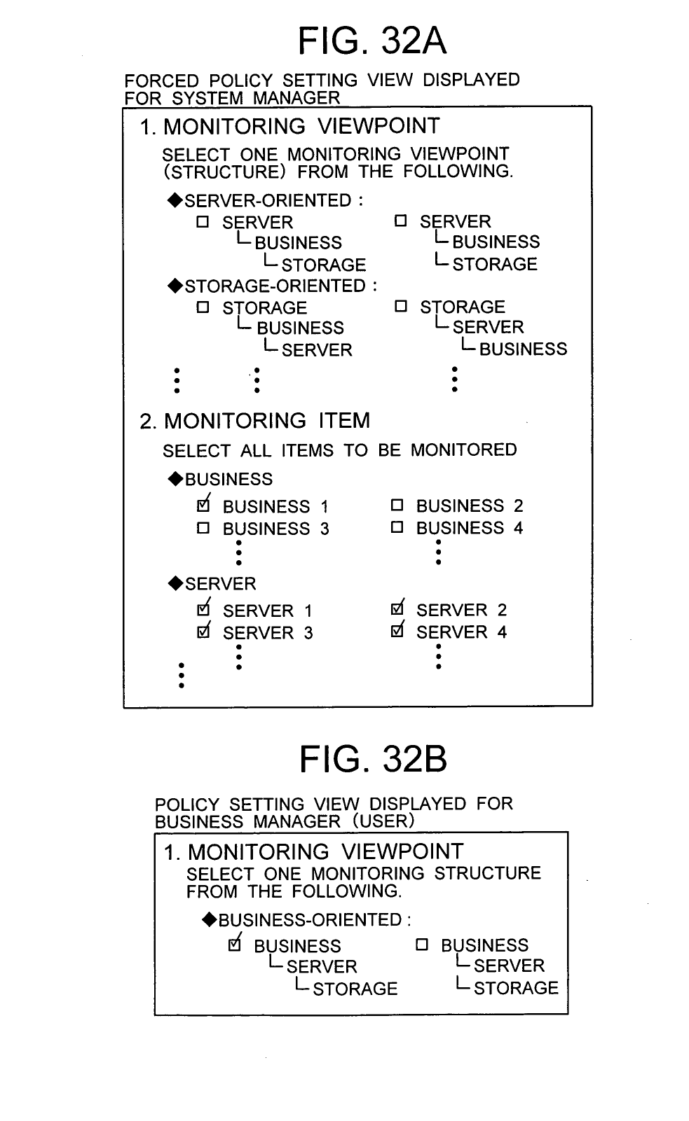

FIG. 32A is a diagram showing an example of a policy setting view at the time of forced policy setting in the present embodiment. FIG. 32B is a diagram showing an example of a policy setting view displayed for the user after forced policy setting. By the way, it is supposed as an example in FIG. 32A that the forced policy setter is a system administrator who manages the whole system. It is supposed as an example in FIG. 32B that a user subjected to the forced policy setting is a business manager of “business 1” executed on the system. As shown in FIG. 32B, in the policy setting view displayed to the user in the present embodiment, a menu for selecting only the “business-oriented” as the monitoring viewpoint is displayed. As for other contents such as the monitoring item, contents selected by the system administrator are used and the user is not given the right of selection.

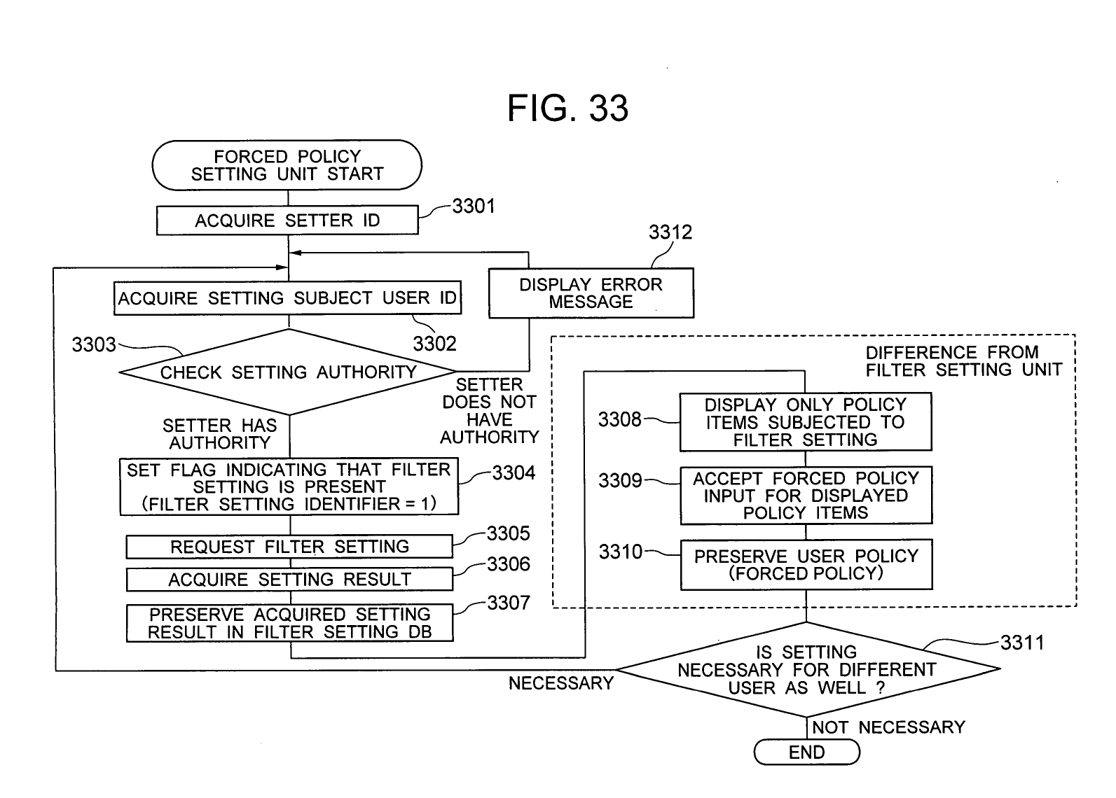

FIG. 33 is a flow chart showing a processing procedure in the forced policy setting unit 3101 according to the present embodiment. At step 3301, the forced policy setting unit 3101 acquires a setter ID for identifying a setter who conducts forced policy setting. At step 3302, the forced policy setting unit 3101 acquires a setting subject user ID for identifying a user for whom forced policy setting is conducted.

At step 3303, it is determined whether the setter identified by the setter ID has authority for setting. If the setter has authority for setting, the processing proceeds to step 3304. If the setter does not have authority for setting, the processing proceeds to step 3312.

At the step 3304, “1” is set in a filter setting identifier of the setting subject user ID, as flag setting indicating that filter setting is present. At step 3305, the setter is requested to input filter setting. At step 3306, a result of filter information setting input by the setter is acquired.

At step 3307, the setting subject user ID, the set filter setting identifier, and the acquired filter information setting contents are preserved in the filter setting DB 2503.

At step 3308, only policy items subjected to the filter setting as described above are displayed again. At step 3309, a forced policy input for the displayed policy items is accepted, i.e., policy setting is accepted with respect to policy items that are not displayed for the user by filter setting. At step 3310, contents of the accepted user policy (forced policy) are preserved in the user policy DB 112 as a user policy corresponding to the setting subject user ID.

At step 3311, it is determined whether there is an input indicating that forced policy setting should be conducted for a different user. If there is an input indicating that forced policy setting should be conducted for a different user as well, the processing returns to the step 3302. If there is an input indicating that filter information should not be set for a different user, the processing is finished.

As described above, in the performance management system according to the present embodiment, it is made possible for a person having authority other than the user to conduct partial or whole policy setting. For example, the user need not set the monitoring item. If the manager of the whole system previously sets monitoring items having relations to respective users, the number of items the user sets can be reduced. If the manager of the whole system previously sets a policy according to the user's authority and division of duties, the burden on the user in the policy setting can be lightened by detaching the monitoring item selection obvious from the division of duties and the like from the policy such as the monitoring viewpoint to be selected by the user.

As heretofore described, according to the performance management system in the present embodiment, partial or whole policy setting is conducted by using preset contents. Therefore, it is possible to lighten the work burden on the user in policy setting.

### Fourth Embodiment

Hereafter, a performance management system according to a fourth embodiment, which generates correlation information by using a business information integration DB having mirrored business information will be described.

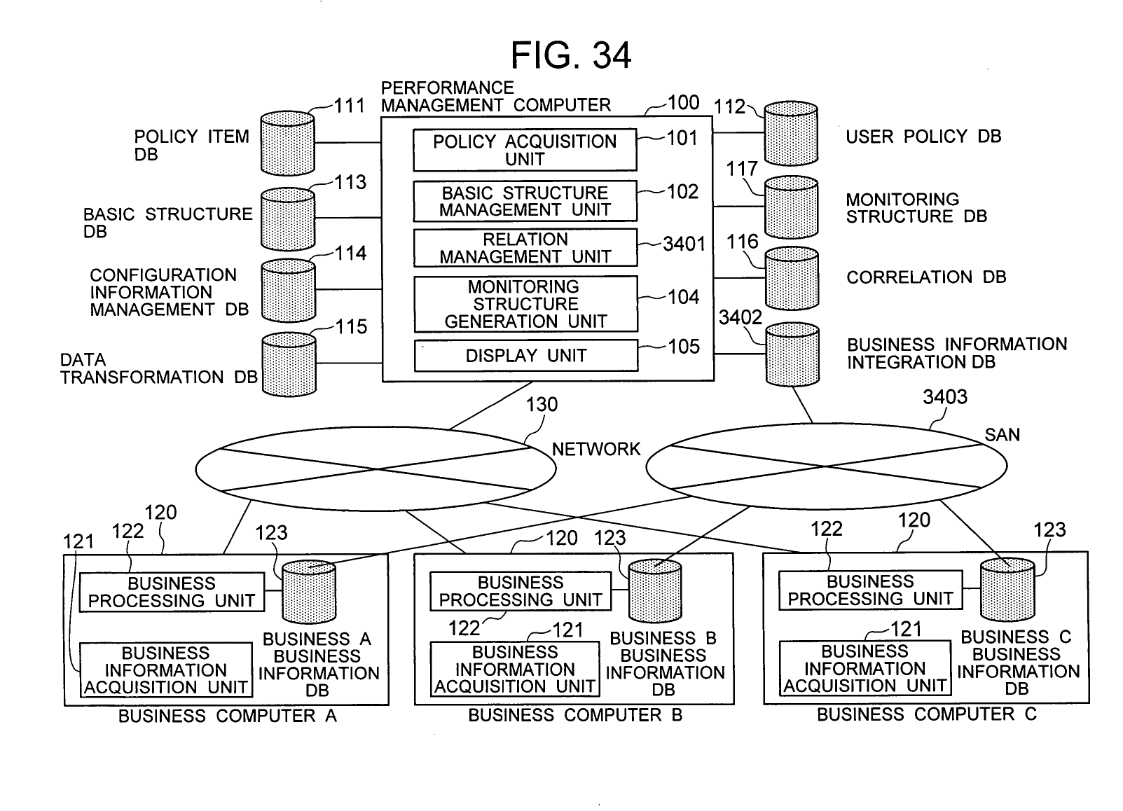

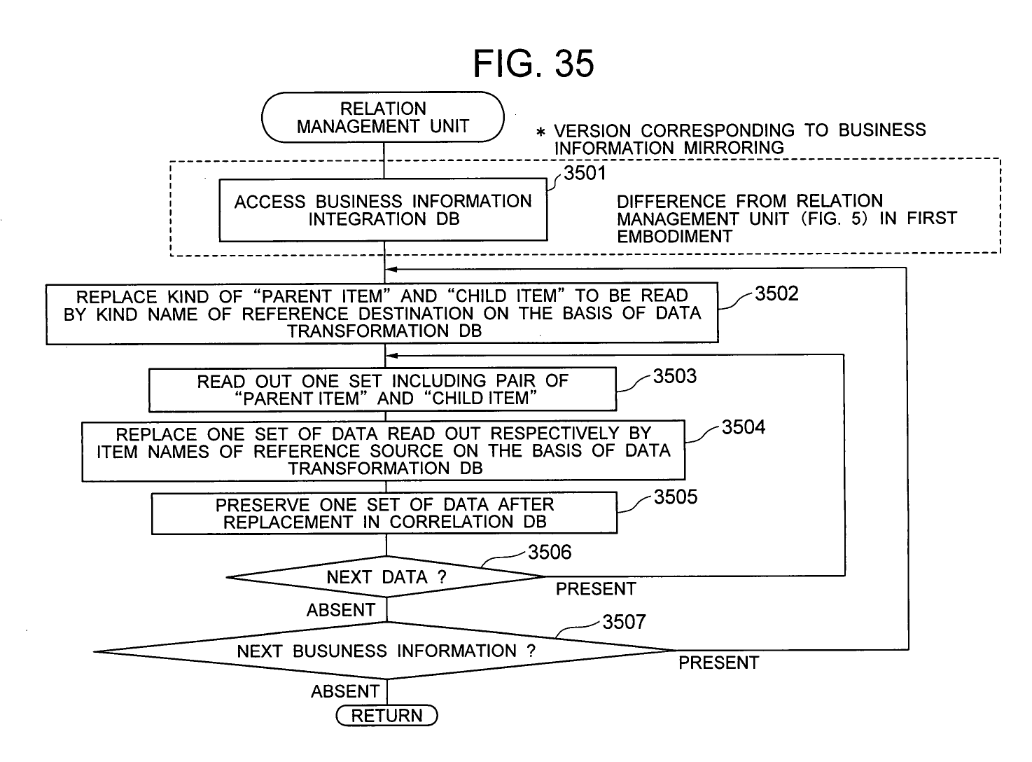

FIG. 34 is a diagram showing a general configuration of a performance management system according to the present embodiment. As shown in FIG. 34, a performance management computer 100 according to the present embodiment includes a relation management unit 3401. The relation management unit 3401 is a processing unit for generating correlation information by using a business information integration DB 3402 having mirrored business information of the business computers.

A program for making the performance management computer 100 function as the relation management unit 3401 is recorded on a media such as a CD-ROM and stored on a magnetic disk or the like, and thereafter loaded in a memory and executed. The media for recording the program thereon may be a media other than the CD-ROM. The program may be installed from the media into an information processing apparatus. Or the program may be used by accessing the media via the network.

Each of other processing units in the present embodiment has a configuration similar to that in the first embodiment.

FIG. 35 is a flow chart showing a processing procedure in the relation management unit 3401 according to the present embodiment. At step 3501, the relation management unit 3401 accesses the business information integration DB 3402 instead of the business information DB 123 in a business computer 120 indicated by whereabouts of business information in the configuration information management DB 114.

At step 3502, a kind name of a reference source of the “parent item” and “child item” to be read is replaced by a kind name of a reference destination on the basis of the data transformation DB 115. Subsequently, at step 3503, one set including a pair of “parent item” and “child item” is read out from the business information integration DB 3402 by using the replaced kind name of the reference destination.

At step 3504, data of the set read out is replaced respectively by item names of the reference source on the basis of the data transformation DB 115. Subsequently, at step 3505, one set of data replaced by the item names of the reference destination is preserved in the correlation DB 116.

At step 3506, it is determined whether the next data is present in the business information integration DB 3402. If the next data is present, the processing returns to the step 3503. If the next data is not present, the processing proceeds to step 3507.

At the step 3507, it is determined whether information indicating whereabouts of the next business information is in the configuration information management DB 114. If whereabouts information of the next business information is present, the processing returns to the step 3502.

By the way, the business information integration DB 3402 always conducts mirroring of information stored in the business information DBs via an SAN 3403.

Furthermore, the relation management unit 3401 does not access each business information DB, but accesses the business information integration DB 3402 to acquire business information.

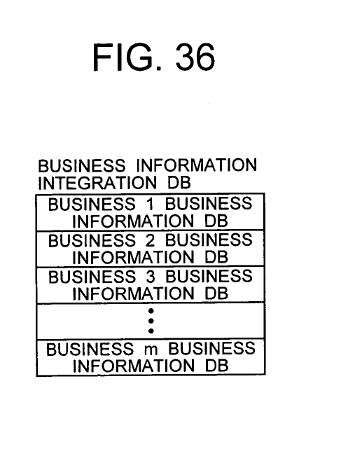

FIG. 36 is a diagram showing a data structure of the business information integration DB 3402 according to the present embodiment. As shown in FIG. 36, the business information integration DB 3402 in the present embodiment has a data structure for storing contents of the business information DBs 123 in the business computers.

By the way, the data structure of the business information DB 123 included in each business computer 120 is grasped by the business information acquisition unit 121. When issuing a data acquisition request to the business information integration DB 3402, it is necessary to once inquire of the business information DB 123 included in each business computer 120 about the data structure. Furthermore, instead of disposing the business information acquisition unit 121 in each business computer 120, functions of the business information acquisition units 121 in the business computers 120 may be collected and disposed in the performance management computer 100.

As described above, in the performance management system according to the present embodiment, the business information integration DB 3402, which retains the business configuration information stored in various business computers collectively, is disposed. The business information integration DB 3402 is linked to the business information DBs 123 of various businesses via the SAN (Storage Area Network) 3403 to conduct mirroring and always maintain the latest information. As a result, information required to create the monitoring structure can be obtained without being passed through a LAN (Local Area Network), and the network load can be lightened. Furthermore, such a performance that only each business manager accesses the business information DB 123 of each business and only the operation manager accesses the business information integration DB 3402 is also possible. In this case, the information reading rate can be increased and access to each business information DB 123 can be limited to only the business manager of the business.

As heretofore described, according to the performance management system in the present embodiment, correlation information is generated by the business information integration DB subjected to mirroring of business information using a storage technique such as the SAN. Therefore, it is possible to lighten the network load, increase the information reading rate, and limit access to business information on each computer.

### Fifth Embodiment

Hereafter, a performance management system according to a fifth embodiment, which detects an alteration of business information and updates monitoring structure information, will be described.

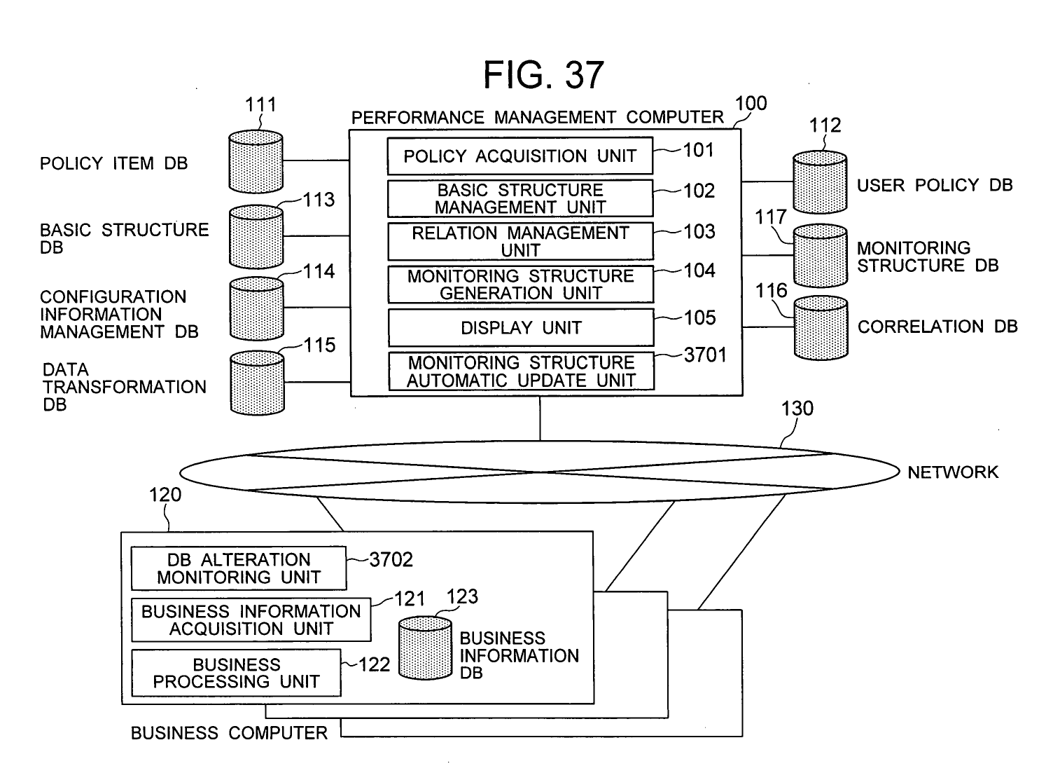

FIG. 37 is a diagram showing a general configuration of a performance management system according to the present embodiment. As shown in FIG. 37, a performance management computer 100 according to the present embodiment includes a monitoring structure automatic update unit 3701. The monitoring structure automatic update unit 3701 is a processing unit for updating the monitoring structure information when a DB alteration monitoring unit 3702 disposed in a business computer has detected an alteration in business information.

A program for making the performance management computer 100 function as the monitoring structure automatic update unit 3701 is recorded on a media such as a CD-ROM and stored on a magnetic disk or the like, and thereafter loaded in a memory and executed. The media for recording the program thereon may be a media other than the CD-ROM. The program may be installed from the media into an information processing apparatus. Or the program may be used by accessing the media via the network.

Each of other processing units in the present embodiment has a configuration similar to that in the first embodiment.

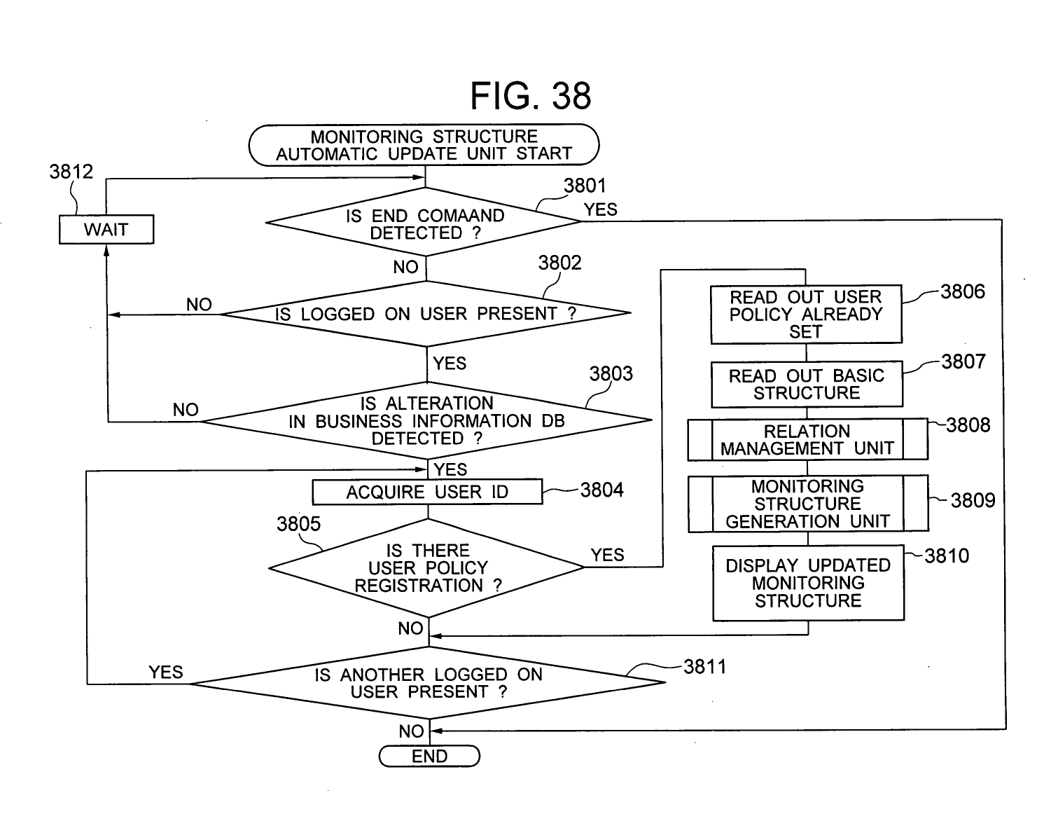

FIG. 38 is a flow chart showing a processing procedure in the monitoring structure automatic update unit 3701 according to the present embodiment. At step 3801, the monitoring structure automatic update unit 3701 determines whether an input of an end command has been accepted. If an input of an end command has been detected, the processing is finished. If an input of an end command has not been detected, the processing proceeds to step 3802.

At the step 3802, it is determined whether a currently logged on user is present. If a logged on user is present, the processing proceeds to step 3803. If a logged on user is not present, the processing returns to the step 3801 after a wait for a predetermined time at step 3812.

At step 3803, the DB alteration monitoring unit 3702 disposed in each business computer determines whether the business information DB 123 has been altered by, for example, comparing the update date and time of the business information DB 123 in the business computer with that obtained the last time. If an alteration in the business information DB 123 is detected, the processing proceeds to step 3804. If an alteration in the business information DB 123 is not detected, the monitoring structure automatic update unit 3701 waits for a predetermined time at the step 3812.

At the step 3804, a user ID for identifying a logged on user is acquired. At step 3805, a registration identifier corresponding to the acquired user ID is read out by referring to the user policy DB 112. It is determined whether registration of a user policy is present by checking whether “1” is set in the registration identifier. If “1” is not set, the processing proceeds to step 3811. If “1” is already set, the processing proceeds to step 3806.

At the step 3806, the user policy already set corresponding to the user ID is read out from the user policy DB 112. At step 3807, the basic structure is read out from the user policy already set.

At step 3808, processing in the relation management unit 103 is conducted. At step 3809, processing in the monitoring structure generation unit is conducted. At step 3810, the monitoring structure already updated is displayed. Details in the steps 3808 to 3810 are similar to those in other embodiments. Alternatively, monitoring structure information may be generated by generating difference information in the monitoring structure information of the user between before and after the alteration on the basis of the difference in the business information DB 123 between before and after the alteration, and conducting addition or deletion of the difference information on the existing monitoring structure information.

At step 3811, it is determined whether there is another logged on user. If another logged on user is present, the processing returns to the step 3804. If another logged on user is not present, the processing is finished.

As described above, in the performance management system according to the present embodiment, the DB alteration monitoring unit 3702 disposed in the performance management computer or each business computer detects update of the business information DB 123 and update of the monitoring structure can be automatically executed in response to the detection serving as a trigger.

As heretofore described, according to the performance management system in the present embodiment, an alteration in business information is detected and the monitoring structure information is updated. Therefore, the monitoring structure can be altered according to an alteration in business information on each computer.

### Sixth Embodiment

Hereafter, a performance management system according to a sixth embodiment, which generates correlation information by referring to only business information that represents business programs or system resources related to a monitoring item selected by a policy, will be described.

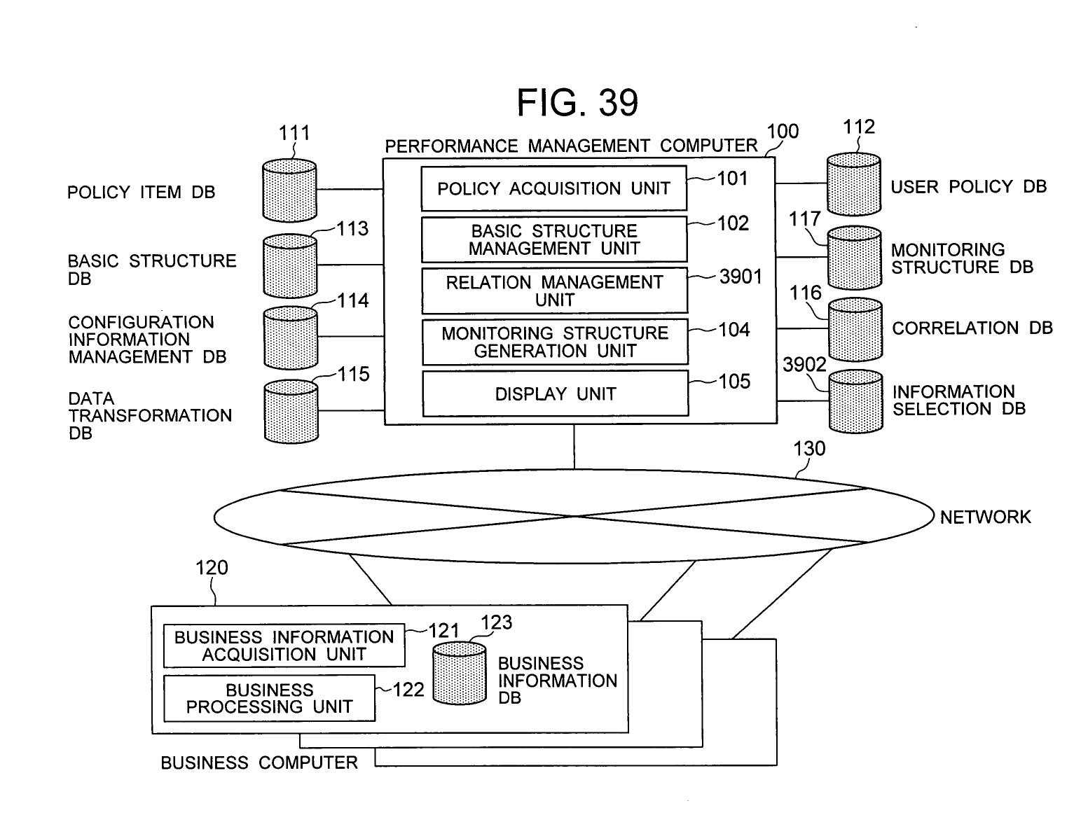

FIG. 39 is a diagram showing a general configuration of a performance management system according to the present embodiment. As shown in FIG. 39, a performance management computer 100 according to the present embodiment includes a relation management unit 3901. The relation management unit 3401 is a processing unit for generating correlation information by referring to only business information that represents business programs or system resources related to a monitoring item selected by a policy.

A program for making the performance management computer 100 function as the relation management unit 3901 is recorded on a media such as a CD-ROM and stored on a magnetic disk or the like, and thereafter loaded in a memory and executed. The media for recording the program thereon may be a media other than the CD-ROM. The program may be installed from the media into an information processing apparatus. Or the program may be used by accessing the media via the network.

Each of other processing units in the present embodiment has a configuration similar to that in the first embodiment.

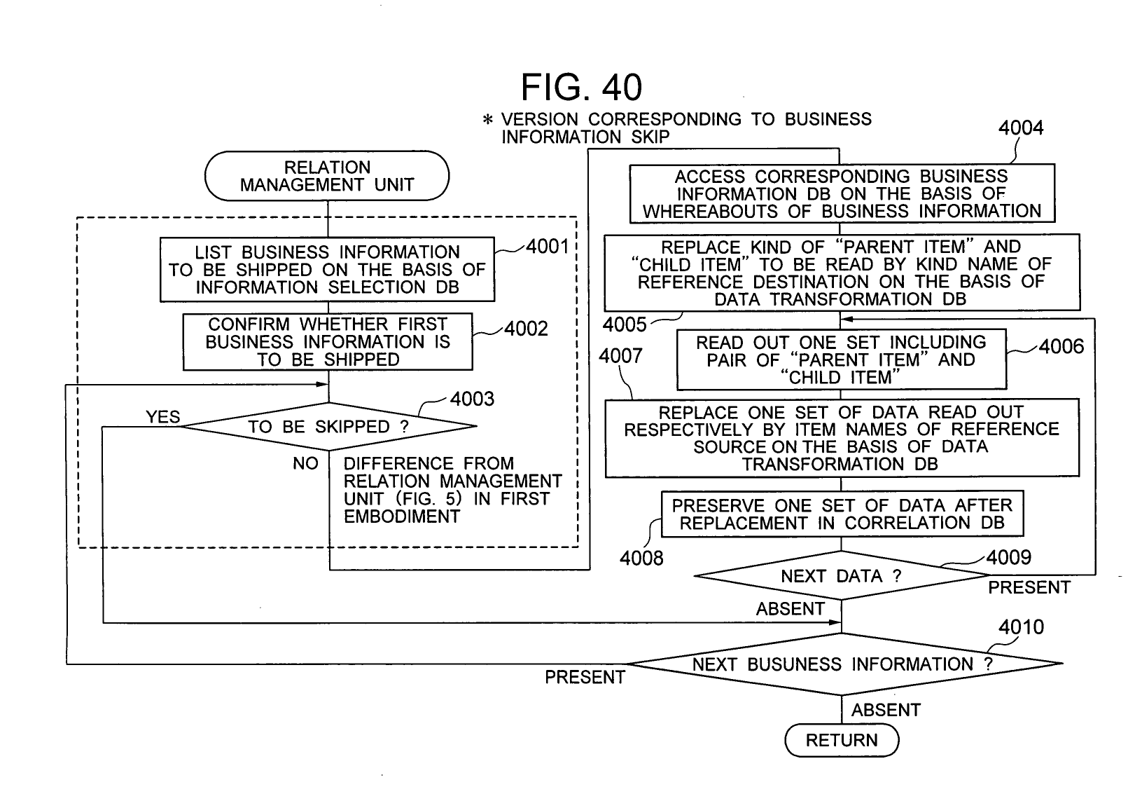

FIG. 40 is a flow chart showing a processing procedure in the relation management unit 3901 according to the present embodiment. At step 4001, the relation management unit 3901 lists business information to be skipped on the basis of an information selection DB 3902. Subsequently, at step 4002, it is ascertained whether to skip first business information.

At step 4003, it is determined whether the business information is to be skipped by referring to a result of the ascertainment. If the business information is to be skipped, the processing proceeds to step 4010. If the business information is not to be skipped, the processing proceeds to step 4004.

At the step 4004, a processing request is sent to the business information acquisition unit 121 in a business computer 120 indicated by whereabouts of business information in the configuration information management DB 114. The relation management unit 3901 accesses the business information DB 123 representing programs or system resources used in processing in the business processing unit 1202 in the business computer 120.

At step 4005, a kind name of a reference source of the “parent item” and “child item” to be read is replaced by a kind name of a reference destination on the basis of the data transformation DB 115. Subsequently, at step 4006, one set including a pair of “parent item” and “child item” is read out from the business information DB 123 by using the replaced kind name of the reference destination.

At step 4007, data of the set read out is replaced respectively by item names of the reference source on the basis of the data transformation DB 115. Subsequently, at step 4008, one set of data replaced by the item names of the reference destination is preserved in the correlation DB 116.

At step 4009, it is determined whether the next data is present in the business information DB 123. If the next data is present, the processing returns to the step 4006. If the next data is not present, the processing proceeds to step 4010.

At the step 4010, it is determined whether information indicating whereabouts of the next business information is in the configuration information management DB 114. If whereabouts information of the next business information is present, the processing returns to the step 4003.

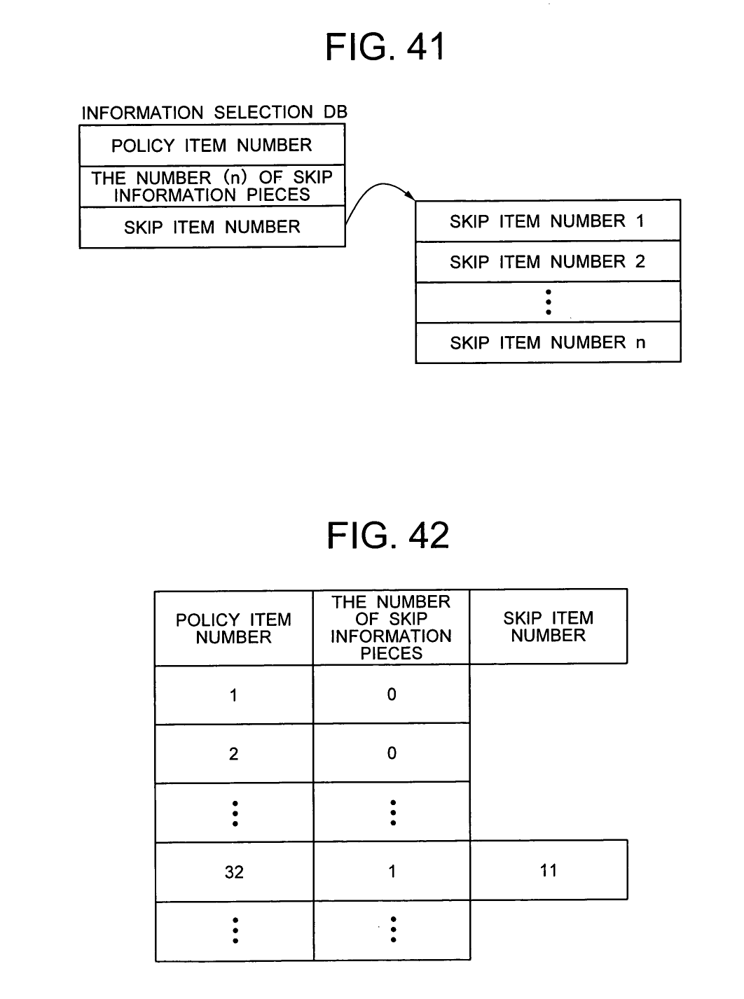

FIG. 41 is a diagram showing a data structure of the information selection DB 3902 according to the present embodiment. As shown in FIG. 41, the information selection DB 3902 according to the present embodiment has a data structure for storing a policy item number indicating a number of a policy item, the number of skip information pieces indicating the number of business information pieces skipped when the policy item having the policy item number is not selected by the user and storing, as information of a skip item number indicating a skip subject, a skip item number indication a configuration information item number of the skipped business information.

By the way, when there is no business information to be skipped, n=0 is set.

Furthermore, the skip item number corresponds to the configuration information item number in the configuration information management DB 114.

FIG. 42 is a diagram showing an example of the information selection DB 3902 in the present embodiment. In the information selection DB 3902 shown in FIG. 42, an example in which, for example, a policy item number “32,” a number of skip information pieces “1” and a skip item number “11” are stored is represented.

As described above, in the performance management system according to the present embodiment, the business information DB 123 subject to readout is altered according to the set policy. For example, in the case where monitoring according to the cluster configuration is not necessary, therefore, access to the clustering software setting information is omitted. By thus omitting access to unnecessary business information, the generation efficiency of the monitoring structure information can be increased.

By the way, if a policy having a policy item number 32 is not adopted in the user policy DB 112, a business information DB 123 having a configuration information item number 11 in the configuration information management DB 114 is not accessed.

As heretofore described, according to the performance management system in the present embodiment, correlation information is generated by referring to only business information that represents programs or system resources having a relation to the set policy. Therefore, it is possible to omit referring to unnecessary business information and increase the generation efficiency of correlation information.

According to the present invention, business information representing programs and system resources used in the computers is utilized to generate the monitoring structure information for monitoring the programs and system resources. Therefore, it is possible to efficiently generate the monitoring structure information representing various structures such as a monitoring structure relating a program to a specific system resource and a monitoring structure relating a specific system resource to another system resource. Furthermore, it is possible to meet needs for system monitoring, which differ from user to user, and generate a monitoring structure suitable for the user.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A performance management method for monitoring states of programs and system resources and managing performance of a computer system, the performance management method comprising the steps of:
referring to business information representing programs and system resources used in computers, and generating and managing correlation information representing correlations among them; and
generating monitoring structure information in accordance with the generated correlation information, the monitoring structure information representing a structure for monitoring the programs and system resources.

2. The performance management method according to claim 1, wherein the monitoring structure information is generated so as to be different from user to user in accordance with a policy set by a user.

3. The performance management method according to claim 2, wherein contents of a menu for setting the policy are altered from user to user.

4. The performance management method according to claim 3, wherein a part or whole of the policy is set by using preset contents.

5. The performance management method according to claim 4, wherein the correlation information is generated by a business information integration DB subjected to mirroring of business information using a storage technique including a SAN (Storage Area Network).

6. The performance management method according to claim 5, wherein an alteration in the business information is detected and the monitoring structure information is updated.

7. The performance management method according to claim 6, wherein the monitoring structure information is updated on the basis of a difference between before and after the alteration in the business information.

8. The performance management method according to claim 7, wherein the correlation information is generated by referring to only business information containing information of necessary programs or system resources, on the basis of the policy.

9. A performance management system for monitoring states of programs and system resources and managing performance of a computer system, the performance management system comprising:
a relation management unit for referring to business information representing programs and system resources used in computers, and generating and managing correlation information representing correlations among them; and
a monitoring structure generation unit for generating monitoring structure information in accordance with the generated correlation information, the monitoring structure information representing a structure for monitoring the programs and system resources.

10. A program for making computers function as a performance management system, which monitors states of programs and system resources and manages performance of a computer system, the program for making computers function as:
a relation management unit for referring to business information representing programs and system resources used in computers, and generating and managing correlation information representing correlations among them; and
a monitoring structure generation unit for generating monitoring structure information in accordance with the generated correlation information, the monitoring structure information representing a structure for monitoring the programs and system resources.
